(19) United States
(12) Patent Application Publication
(10) Pub. No.: US 2026/0357372 A1
(43) Pub. Date: Nov. 12, 2026

(54) MICROWAVE-ASSISTED METHODS TO RECOVER CRITICAL MATERIALS FROM ELECTRONIC WASTE

(71) Applicant: West Virginia University Board of Governors on Behalf of West Virginia University, Morgantown, WV (US)

(72) Inventors: Terence MUSHO, Bruceton Mills, WV (US); Edward SABOLSKY, Morgantown, WV (US)

(21) Appl. No.: 19/122,343

(22) PCT Filed: Oct. 18, 2023
(86) PCT No.: PCT/US2023/077127

§ 371 Date: Apr. 18, 2025

Related U.S. Application Data
(60) Provisional application No. 63/380,227, filed on Oct. 19, 2022.

(51) Int. Cl. C22B 7/00; C22B 47/00

(52) U.S. Cl. CPC C22B 7/001; C22B 47/00

(57) ABSTRACT

In one aspect, the disclosure relates to a method to recover at least one metal from electronic waste, the method including at least: (a) pyrolyzing electronic waste, wherein the electronic waste comprises the at least one metal and one or more organic components, and wherein the pyrolyzing forms a composition comprising pyrolyzed electronic waste and pyrolyzed carbon; (b) contacting the composition with an oxidizing agent and oxidizing the composition using microwave heating to form an oxidized composition comprising at least one metal oxide containing the at least one metal; and (c) applying microwave heating to the oxidized composition, wherein the microwave heating causes carbothermal reduction, carburization, and/or nitridation to form the at least one metal, metal carbide, or metal nitride from the at least one metal oxide that can be physically separated. The at least one metal can be Ga, In, Ta, or Cu.

### CROSS-REFERENCE TO RELATED APPLICATIONS

This application claims the benefit of U.S. Provisional Application No. 63/380,227, filed on Oct. 19, 2022, which is incorporated herein by reference in its entirety.

### STATEMENT REGARDING FEDERALLY SPONSORED RESEARCH OR DEVELOPMENT

This invention was made with government support under grant number HR0011-22-9-0123 awarded by the Defense Advanced Research Projects Agency (DARPA). The government has certain rights in the invention.

### BACKGROUND

About 57 million metric tons of electronic waste (e-waste) were generated in 2021 with that total growing by an average of 2 million metric tons per year. A little less than 20 percent of e-waste is known to be collected and properly recycled. Information and Communication Technology (ICT) metals such as indium (In), gallium (Ga), tantalum (Ta), and copper (Cu) typically contained within e-waste are valuable commodities with uncertain supply chain outlooks, particular as ICT device growth continues to burgeon worldwide. Alternate ICT metal feedstocks are highly desirable.

There are two conventional approaches to recovery, hydrometallurgy and pyrometallurgy. Often these are used in combination for select materials. Hydrometallurgy typically relies on acids to dissolve select elements from the e-waste into a solution and precipitate out the selected elements from the composition. Pyrometallurgy relies on a high-temperature smelting process to use a series of reduction and oxidation reactions to capture the selected elements. In both these approaches, it often is necessary to maximize the concentration of the minerals of interest before conducting the process. This means removing components using robotic selection, crushing select components, and separating off lightweight materials such as plastics. Eliminating steps from the process of metal recovery from e-waste would save time and reduce equipment requirements in processing plants.

An electro-discharge method of reducing metals has been attempted. For example, this is often done during the smelting of aluminum. However, often these methods cannot achieve very rapid temperature ramp rates. Often, the reason for the limited ramp rate in these electro-discharge approaches is the oxide is not electrically conductive, therefore it is difficult to pass a current through the material.

End-of-life electronic waste (e-waste) also includes copper and copper alloys such as bronze and brass. Copper represents 20 and 30% of e-waste mass. High-purity copper is found in all modern electronics but has specific application in electric motors and long distance power transmission as well as in heating ventilation and air conditioning (HVAC) heat pump units and electric automobiles. With regard to long distance power transmission, use of copper is important in off-shore renewable power generation, where efficient transmission of electricity over long distances provide considerable energy savings. As the economy transitions to off-shore renewable energy sources, there is a need for high-conductivity transmission that is projected to increase domestic demand for copper.

One of the major issues with recycling copper is the abundance of copper alloying elements in mixed streams of copper scrap. The most troubling of these alloying elements is lead. For years lead was purposely added to copper because of its aid in machining since it acts as a natural lubricant. Lead-based solders were also heavily used because of their reliability on printed circuit boards (PCBs). However, the separation of lead from copper is a difficult task stemming from their similarities in physical and thermodynamic properties. The trend in the industry is to dilute scrap copper with pure copper down to an acceptable lead level or to use an ore-derived source of copper. Neither of these are sustainable practices. Moreover, the United States is the largest exporter of scrap copper despite being the fifth global producer of copper from ore. This means a large portion of the copper scrap exported has a foreign dependence.

Despite advances in e-waste recycling research, there is still a scarcity of e-waste recycling methods that reduce growth of e-waste production while also providing alternate feedstocks for ICT metals and other commercially important metals. These needs and other needs are satisfied by the present disclosure.

### SUMMARY

In accordance with the purpose(s) of the present disclosure, as embodied and broadly described herein, the disclosure, in one aspect, relates to a method to recover at least one metal, at least one metal carbide, or at least one metal nitride from a mixed electronic waste stream, the method including at least the steps of:
(a) pyrolyzing electronic waste, wherein the electronic waste comprises the at least one metal or metal oxide and one or more organic components, and wherein the pyrolyzing forms a composition comprising pyrolyzed electronic waste and pyrolyzed carbon;
(b) contacting the composition with an oxidizing agent and oxidizing the composition using microwave heating to form an oxidized composition comprising at least one metal oxide containing the at least one metal; and

(c) applying microwave heating to the oxidized composition, wherein the microwave heating causes carbothermal reduction, carburization, nitridation, or a combination thereof, to form the at least one metal, at least one metal carbide, or at least one metal nitride from the at least one metal or metal oxide.

In one aspect, the at least one metal can be an information and communication technology metal such as, for example, Ga, In, or Ta, or can be another commercially important metal such as Cu.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described embodiments are usable in all aspects of the disclosure taught herein. Furthermore, the individual features of the dependent claims, as well as all optional and preferred features and modifications of the described embodiments are combinable and interchangeable with one another.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIGS. 1A-1C show results from previous microwave studies that were used to inform the disclosed process. FIG. 1A shows a photograph of a 3 KW multi-mode microwave system useful in the disclosed methods. FIG. 1B shows a COMSOL simulation illustrating the temperature profile of microspheres formed from an oxidizing agent useful in the disclosed processes. FIG. 1C shows a simulation illustrating the localized electric field around the microspheres.

FIG. 2A shows a phase diagram for a GaN system and FIG. 2B shows a phase diagram for a Ta—O system. The arrows with identifier numbers in circles are hypothetical routes for achieving Ga(s) and Ta(s). Note the temperature requirements for both GaN and Ta₂O₅, approximate 2000 K. Similar phase diagrams were generated based on computationally derived thermodynamic data for the disclosed carbothermal method.

FIG. 3 shows an experimental time history cooling diagram for a Ta—Hf—O system. The time history can be monitored in-situ during the microwave process and used to validate the computationally derived phase diagrams. The changes in slope indicate entropy changes and plateaus indicate enthalpy changes, which can be correlated with phase transformation on phase diagram.

FIGS. 4A-4B are diagrams illustrating a single mode reactor with a flow through design useful in an embodiment of the present disclosure. FIG. 4A is a side view while FIG. 4B is a cross-sectional review. The single mode system allows precise control of incident EM field and subsequent heating profile.

FIG. 5 is a flow chart showing an overall process example according to one embodiment of the present disclosure.

FIGS. 6A-6B show x-ray analysis for e-waste pyrolysis byproducts. FIG. 6A shows the XRF elemental components of the by-products. Copper makes up approximately 20% of the material or 200 g/kg of e-waste. Lead is about 0.6% or 6 g/kg of e-waste. FIG. 6B shows the XRD quantitative powder analysis of the crystalline phases with selected major products labeled. The largest phases copper oxide tenorite (CuO) and cuprite (Cu₂O) with other oxide phases (SiO₂, SnO₂, and the like). Lead is present as an alloying element in copper oxide. Moreover, the pyrolysis and high temperature oxidation in atmospheric air has roasted all metallic fines to oxides, which presents microwave refining with opportunistic material to refine.

FIGS. 7A-7B show preliminary scoping run of microwave refining copper oxide (CuO) and lead oxide (PbO). FIG. 7A shows a crucible with condensed phase of lead (i) and copper aluminum oxide or copper carbide (ii). FIG. 7B shows metal sponge spheres of pure copper (iii-v). Black material is residual carbon. Optimization of flux addition is necessary to optimize process and avoid reaction with alumina container.

FIG. 8A shows a ternary phase diagram of Pb—Cu—O system at 1250 °C, which illustrates the solubility of Pb in copper oxide. Very little Pb (0.5%) will form a stable alloy with Cu metal. Copper oxide can support approximately 4.5% of Pb. FIG. 8B is an Ellingham Diagram, which illustrates the states of interests and associated processing temperatures and partial pressure of oxygen.

FIGS. 9A-9C show the recovery process for Ta from mixed stream e-waste developed for Ga, In, and Ta recovery but also useful for Cu recovery. FIG. 9A shows the glowing of the crucible and the emission of a CO plasma. FIG. 9B shows a metal sponge Ta material recovered after microwave refining. FIG. 9C shows Mn₃C powder that condensed out of the plasma onto the top of the lid (reaction crucible under lid).

FIG. 10 shows an illustration of a custom 3D printed microwave upper and lower applicator for a single mode microwave generator. The applicator is connected to a WR304 waveguide. The upper applicator collects condensed phases that results from secondary reaction with injected gas. The lower condenser collects metal sponge phases. Xometry from American Makes Network was used to fabricate 3D metal printed prototype applicators.

FIG. 11 shows Ellingham diagram for Ta refinement. All quantities are at referenced to standard conditions. The left most figure is the oxidation-reduction reactions. The right most figure is the nitride and carbide reactions. This plot illustrates the thermodynamics of the reaction. Reactions towards the top of the y-axis are more noble. This plot also illustrates at what partial pressures of O₂ or N₂ are required to have equilibrium of a given state. Major finding from these figures is that Ta₂O₅ (l), Ga₂O₃ (g), and In₂O₃ (g) can be reduced with CO.

FIG. 12 shows Ellingham diagram for Ga and In refinement. All quantities are at referenced to standard conditions. On the left are oxidation-reduction reactions. On the right are nitride and carbide reactions. In and Ga and can be reduced in tandem to conserve energy of the reaction.

FIG. 13 shows a flow chart of the associated processing steps for fractional recovery from a mixture of a four-element e-waste. At each temperature step materials are selectively removed.

FIG. 14 shows an Ellingham Diagram associated with each of the temperature processing points shown in FIG. 13. The microwave partial pressure is maintained between 10-15 atm and 10-18 atm by using a combination of vacuum and Ar purge gas. The process involves a series of selective reduction steps to convert or recover lower oxides or raw metal sponge material.

FIG. 15 shows an illustration of the process similar to FIG. 13 except a nitrogen atmosphere is used in this case. There is a difference is the formation that includes metal sponge materials forming during cycle 3 and absence of an agglomerate material during cycle 1.

FIGS. 16A-16F show phase diagrams that were used to refine the disclosed process. These cycle numbers refer to Table 3. Both the temperature (top of figures) and pressure (y-axis of figures) were maintained to form the corresponding phases. These diagrams demonstrate that the CALPHAD calculations indicate good predictive capability when compared to experimental results.

FIGS. 17A-17B show updated processing for Cycle 3 (see Table 3) that forms Mn₇C₃ and Ga metal on bottom of crucible. This is achieved by increasing carbon addition to 0.26 g and slightly elevating the pressure to 0.1 atm. Ga_{(liq)} forms a deposit of material on the side of crucible. The Ga_{(liq)} can be converted to oxide by post oxidation reaction step.

FIG. 18 shows XRD results of metals recovered by deposition on side of crucibles. XRD patterns were taken of metals deposition on alumina substrate as seen in the inset image. These metalized layers will be converted to oxides by reheating under oxidative atmosphere.

FIGS. 19A-19B show the results of the microwave reactor runs for the first cycles, Cycle 1a and Cycle 1b. The top plots at the temperature measured by the pyrometer, which was 900 °C. X-axis on all plots is wall time. These runs were run for 6 min of wall time. The bottom plots in each figure are the forward and reflected power. Notice the similarity between cycle 1a (FIG. 19A) and 1b (FIG. 19B), demonstrating the reproducibility of the experimental runs and subsequent proposed process. The forward and reflected power exponentially decays after 3 min to a value equivalent to the heat loss from the reaction vessel. This is evidence the reaction has completed after 3 min resulting in a self-limiting process.

FIG. 20 shows Cycle 2 (TaC formation) temperature time history (top) and the forward and reflected microwave power (bottom). There is a dip in the forward and reflected power at 4 min mark indicating end of reaction. This provides evidence of a self-limiting reaction after TaC is formed.

FIGS. 21A-21B show SEM images of agglomerates from microwave testing runs of Ta capacitor powder and carbon. Alpha-Ta and TaC were primary components according to XRD analysis after processing.

FIG. 22 shows a polished cross section of a Ta agglomerate from a run depicted in FIGS. 21A-21B. The microstructure is confirmed to be a metal sponge type material.

FIG. 23 shows XRD analysis of a Ta agglomerate from a run depicted in FIGS. 21A-21B.

FIGS. 24A-24B show SEM images of Ta capacitor anode material after pyrolysis. FIG. 24B is a closer view of a portion of the image in FIG. 24A.

FIG. 25 shows the recovery process for Ta capacitors only e-waste material. Ta capacitors are removed from PCBs as shown in figure. Ta capacitors are pyrolyzed and crushed, followed by a three cycle microwave process. A photo of the TaC is removed as a stable phased in Cycle 2 is shown. A photo of Mn₇C₃ stable phase mixed with carbon is shown as a results of Cycle 3.

FIGS. 26A-26E show phase diagrams that were used to refine the disclosed process. These phase diagrams are associated with the three cycle process shown in FIG. 25. Both the temperature and pressure of the process are controlled under an argon atmosphere.

FIG. 27 is a x-ray diffraction of the TaC agglomerate as a results of Cycle 2 shown in FIG. 25. The phase is a well-formed TaC phase will little other phases present.

FIGS. 28A-28D show recovery hardware compatible with one embodiment of the present disclosure.

Additional advantages of the invention will be set forth in part in the description which follows, and in part will be obvious from the description, or can be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### DETAILED DESCRIPTION

In one aspect, disclosed herein are a system and methods thereof to recover information and communications technology (ICT) metals including, but not limited to, indium (In), gallium (Ga), tantalum (Ta), and copper (Cu) from electronic waste (e-waste) using a microwave-driven carbothermal reduction (CTR) approach. In some aspects, manganese (Mn) can also be recovered using the disclosed processes. CTR approaches are currently performed using a conventional heating approach with low temperature ramp rates (e.g., °C/s). One limitation of these conventional heating approaches is a poor ability to rapidly achieve the temperatures necessary to recover select elements, such as Ta. This limitation stems from the difficulty in heating low thermally conductive oxide materials throughout a reactor using a conventional heating approach.

Meanwhile, the present methods allow recovery of e-waste components in a clean process that does not require the use of toxic, corrosive, or harmful chemicals or solvents, while the present system can be designed in a modular fashion to maximize output and be integrated easily into existing processing lines. In one aspect, a minimum projected yield of recovered metals using the disclosed process exceeds 20 grams per hour at greater than 50% recovery and at least 80% purity while requiring lower energy inputs than smelters and/or refineries used in known pyrometallurgical recovery processes.

In one aspect, the presently disclosed system and methods can rapidly heat these low thermally conductive materials and deposit the heat flux within the center of a reactor. In a further aspect, the current method and system, by achieving an extremely high heating rate, vaporize the constituent materials and transition to a gas-phase reaction as opposed to a solid-state reaction mechanism. In a still further aspect, this results in an order of magnitude increase in the speed of ICT metal recovery and provides a broader processing window that is not achievable from a conventional heating perspective.

In one aspect, because the e-waste material is already phase separated based on its original function, it is not necessary to reduce all e-waste present in the reaction vessel to a molten or liquid state as is done in batch pyrothermal processing. Selective spatial reduction of metal oxides in the vicinity of the reducing agent can significantly reduce energy requirement.

In one aspect, the selective reduction processing temperature and pressures, and heterogeneity of the e-waste mixed oxide feedstock results in a self-limiting reduction process. The microwave strongly couples with carbon and the absence of this material reduction of the oxide during the formation of CO results in a self-limiting process.

In one aspect, achieving a high heating rate from the microwave source is technically challenging. Several enhancements previously performed and applied herein involve adding iron oxide, in one nonlimiting example, to the e-waste mixture to help absorb microwave energy by acting as a microwave sink and provide exothermic energy to the system by reducing the oxide. In a further aspect, this strategy can be combined with a CTR approach successfully employed to recover rare earth elements (REEs) from coal fly ash. In another aspect, CTR with the addition of a post nitridation step (CTRN) can result in a stable phase separation of In, Ga, and Ta in a nitride state or pure solid phase. In a still further aspect, this mechanism is reliant on thermodynamic properties of the participating materials and their reaction pathways that can be enhanced by the microwave process. In one nonlimiting aspect, a resonant microwave applicator can be used to hold the sample and capture evaporated and condensed phases. In an aspect, the disclosed system and method can minimally achieve a yield greater than 20 grams per hour at over 50-percent recovery and 80-percent purity.

In one aspect, in the disclosed microwave approach, separation of plastics from other components of e-waste may not be necessary. In a further aspect, the microwave can pyrolyze all organics into carbon black or soot. Further in this aspect, the carbon black can be used during the carbothermal reduction process (CTR) as a reducing agent to convert metal oxides (e.g. Ga₂O₃, In₂O₃, and Ta₃O₅) into elemental metals (e.g. Ga, In, Ta). In another aspect, the disclosed microwave approach relies on dielectric heating when the medium is non-conductive and will transition to electrical losses when the medium becomes electrically conductive.

In one aspect, the e-waste feedstock can be sourced from power electronics, including, but not limited to, high electron mobility transistors (HEMTs) or light emitting diodes (LEDs). In one aspect, the disclosed approach involves the use of microwave radiation to heat low conductive oxide and nitride materials. In a further aspect, the disclosed approach transitions the recovery process to a non-equilibrium gas-phase reaction. In one aspect, this transition can be achieved by using a microwave system to produce an extremely high, localized heating rate compared to conventional heating methods.

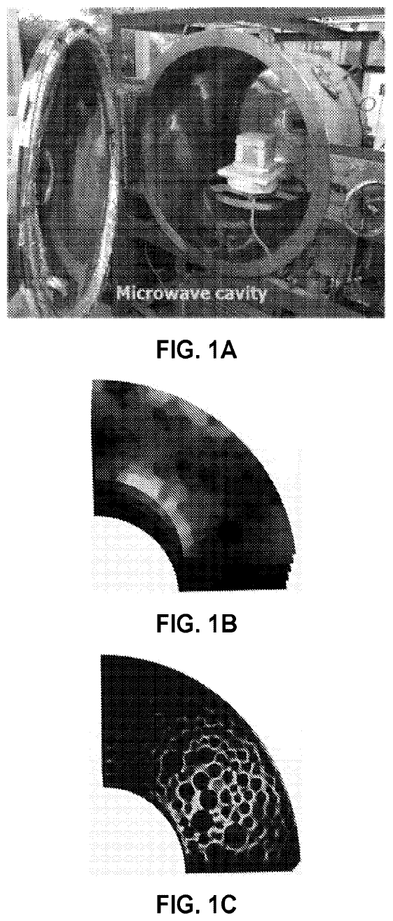

In another aspect, additional components or steps can be incorporated into the reaction to further enhance the microwave heat rate. In one nonlimiting example, one such component or step can be the initial formation of a coreshell structure with an iron oxide core surrounded by a dielectric shell as a result of ball milling the e-waste feedstock in a magnetite (Fe₃O₄) matrix. In a further aspect, and without wishing to be bound by theory, this can result in an electrically conductive core and a ceramic layer that is a dielectric and contains the constituent elements of interest. Magnetite couples with the RF microwave energy resulting in high heating rate. In a further aspect, it has been demonstrated (illustrated in FIGS. 1B-1C) that this coreshell structure is favorable for microwave coupling. In an aspect, not only can the microwave reactor effectively heat these low thermally conductive oxides within the shell, but the heating is localized and enhanced by the spherical shape and neighboring particles. In another aspect, the magnetite core can provide exothermic energy to the reaction during the reduction process. In a further aspect, iron does not form a stable bulk nitride phase at the end of the process that allows for easy extraction at the end CTR-N process. In one aspect, the energy used during the CTR-N process is reduced significantly because it is not necessary to achieve a total heat flux as high as what is required for a conventional heating approach. Further in this aspect, only the localized temperature around the core-shell microspheres must be sufficiently high enough to vaporize the constituents. In still another aspect, this means the total mass of the e-waste does not need to be heated to the desired temperature, but only to the local temperature.

In an aspect, the microwave heating approach heats the e-waste sample from within, locally, from the inside out. This is an important difference from a conventional or arc heating approach that requires heat conduction through the sample from the heat source. In one aspect, based on the thermal mass and localized heat profile from previous microwave studies, the energy savings is similar and comparable to a conventional heating approach and upwards of a 60 percent reduction in the electrical power requirement. This includes consideration of the radio frequency (RF) source (e.g. magnetron, gyrotron, solid-state).

In another aspect, disclosed herein is a nitridation processing step during the CTR process, or CTR-N. The CTR-N process can result in a solid homogenous phase separation as seen in coal fly ash CTR studies. In one aspect, it was observed that metallic spherical phases form on the surface of the carbon. Without wishing to be bound by theory, this was shown to be due to different melting temperatures and the phase stability or lack thereof between REEs and carbon. In a further aspect, the nitridation step can also induce the formation of the nitride/nitrate phases of REEs and Ga, In, and Ta, which is stable for these elements. Examples of REEs that form stable nitride/nitrate phases include, but are not limited to, LaN, CeN, and YbN. In a still further aspect, method of nitridation can stem from the purification method of uranium in the form of uranium nitride from uranium oxide. In another aspect, and without wishing to be bound by theory, it can be advantageous to achieve a nitride phase compared to an oxide phase because it aids in the final purification step and delineates the composition from the incoming feedstock. In another aspect, another advantage of the nitridation phase is that iron does not form a bulk nitride or nitrate phase. Further in this aspect, this means that magnetite added to the system during the oxidation phase can be easily extractable and recycled at the end of the process. In one aspect, a post processing step can also be added using a molten salt or electrolysis extraction process to achieve over 99 percent purity from the final nitride or metal phase.

In one aspect, past work involved a microwave CTR process for the extraction of REEs from coal fly ash. Coal fly ash is a by-product of coal-fired power plants and is mainly comprised of silicate encapsulating REE containing minerals. In a further aspect, the CTR process in the absence of the nitridation process demonstrated the extraction of a low concentration of REE minerals from silicates wherein selective metal reduction was achieved, followed by oxidation in atmospheric conditions. In one aspect, the post-run sample after microwave CTR has a defined separation of the oxide materials and carbon material. In an aspect, microscopic investigation of the carbon surface post-run sample revealed microspheres of metals and metal oxides, analogous to phase separation of ICT metals in the present disclosure.

In another aspect, in addition to studying CTR for REE, the microwave conversion of coal chars was investigated using pyrolyzed coal, with the demonstration of new processing windows for dry reforming of methane at lower pressures. In one aspect, in these studies, a core-shell structure was formed and proven to enhance the heating in the microwave system. This is illustrated in FIGS. 1B-1C. In another aspect, simulation was used to determine the localized temperature and the heat rates; it was determined that the heating rate was 3000 °C/s compared to 150 °C/s for a conventional heating approach.

In one aspect, the technology disclosed herein has relevance to many Department of Defense (DoD) applications that involve the recycling or destruction of DoD e-waste such as, for example, all communication devices, satellites in orbit, war fighters' electronics, high performance computing (HPC) components, tantalum capacitors, transistors, aviation components, gallium nitride high electron mobility transistors, vehicle electronic control modules (ECMs), liquid crystal display (LCDs), and light emitting diodes (LEDs). In one aspect, it is believed that the e-waste will be mainly derived from gallium nitride high electron mobility transistors (GaN HEMT), which also may contain In and Ta. In another aspect, it is believed that the e-waste for Ta can be derived from surface mount capacitors. In another aspect, In and Ga can be derived from LCD and LEDs. In still another aspect, in a majority of these e-waste products, the substrate and interconnects are made of Cu. In a further aspect, the disclosed technology is well suited for modular deployment such that it could be transported by rocket, satellite, airplane, or vehicle.

### Carbothermal Reduction (CTR) Methodology

The present disclosure describes a microwave-driven e-waste recycling approach using a carbothermal reduction (CTR) methodology. In one aspect, elements of interest contained within e-waste are Ga, In, Ta, and Cu, which are commonly derived from HEMT, surface mount capacitors, liquid crystal displays (LCDs), and light-emitting diodes (LEDs). In a further aspect, Ta is an element of high interest and is considered the most difficult of the three elements to recycle. In one aspect, the difficulty in recycling Ta stems from its as-received form being (1) a stable oxide state, (2) having low thermal conductivity, and (3) a high melting point. In an aspect, a microwave-based approach in conjunction with an advanced reduction methodology significantly lowers the barrier to recovery and aids in the recycling process. In another aspect, one advantage of a microwave-driven approach compared to a conventional heating approach is the ability to rapidly heat low thermally conductive oxide materials. In one aspect, in the case of CTR of silicon dioxide, which in some respects is similar to tantalum pentoxide, the bulk temperatures that must be achieved is near 1700 °C at atmospheric pressure. In a further aspect, and without wishing to be bound by theory, how quickly this temperature is achieved has been shown to influence the reaction rate and product distributions. Further in this aspect, the reason for this is the rate of heating governs the reaction rates during the CTR process by shifting the reaction process to a gas phase reaction, rather than a solid-state phase reaction. In addition to achieving a gas phase reaction, in one aspect, the peak localized temperatures are much higher for a microwave approach than for conventional heating. In a further aspect, this means conventional heating processes such as vacuum metallurgy separation (VMS) require a vacuum (e.g., 0.01-0.1 Pa) to achieve lower vaporization temperatures.

In previous work the conversion of coal chars (carbon) with a dry reforming process was investigated. In an aspect, coal chars are similar in composition to the carbon added during the CTR process. In a further aspect, this previous work demonstrated that the microwave system enhances the thermodynamics by achieving reaction products at atmospheric pressures that require much higher pressure to evolve said reaction using conventional heating. In one aspect, the microwave system achieves a much higher surface temperature than the bulk temperature and substantially larger heating rate when compared to conventional heating. For example, in the case of a coal char in a 3 KW single-mode microwave system initially at room temperature, the conventional heating approach (with the same power input) was only able to achieve 150 °C/s while the microwave approach can achieve 3000 °C/s. In a 60 ms time interval, the microwave system was able to achieve a surface temperature of 107 °C greater than a conventionally heated sample. In another aspect, this induces vaporization of the solid phases transitioning to a gas-phase reaction. More interesting, if a conductive particle and/or catalyst such as magnetite is added, in one aspect, the heating rate and subsequent reaction rate is enhanced along with product distribution.

In an aspect, magnetite provides additional exothermic energy to the reaction and the iron can be extracted during the nitridation step. In another aspect, at the end of the process, Ga, In, and Ta are present in either in homogenous phases on the surface of the carbon or in a nitride phase separated from the carbon phase.

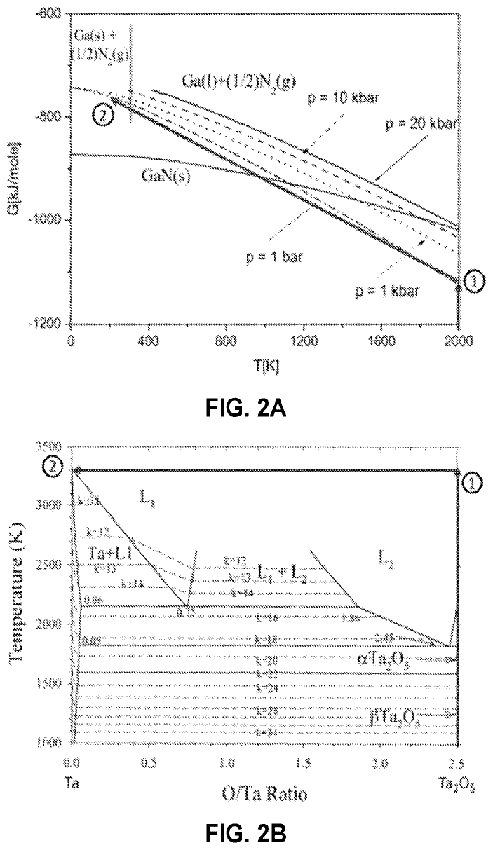

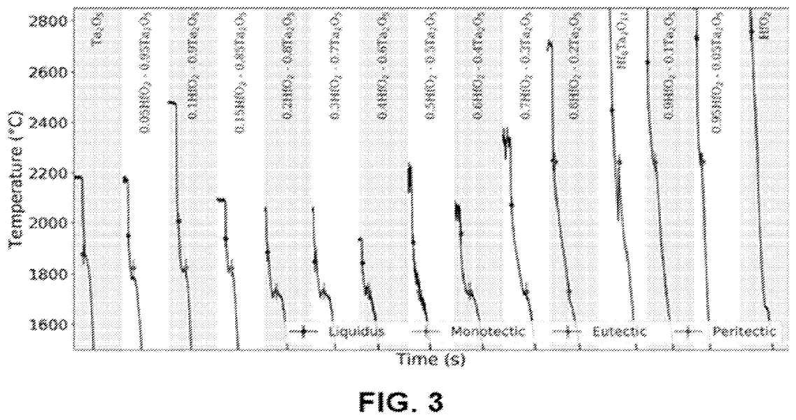

In still another aspect, the thermodynamic characterization of CTR of Ga, In, and Ta is important for e-waste recycling. In one aspect, Ta is an element of high interest. In another aspect, because of the low saturated vapor pressure and subsequent melting temperature of Ga and In, these materials have known to be removed using a VMS process. However, in still another aspect, there is difficulty in heating the nitride and oxide phases. Both GaN and Ta₂O₅ have high melting temperatures as seen in the equilibrium phase diagram of FIGS. 2A-2B. In one aspect, a similar approach is provided in the present disclosure, but at atmospheric pressure while achieving much higher localized temperature during the microwave heating process. In a further aspect, to separate Ta, which is in the form of a gate oxide, Ta₂O₅, and GaN and InN, a microwave-driven CTR process with a nitridation step is relied upon. In a similar aspect, in the separation of Ta, a microwave-driven CTR process with a carbonization step can also be utilized.

### Reaction Process

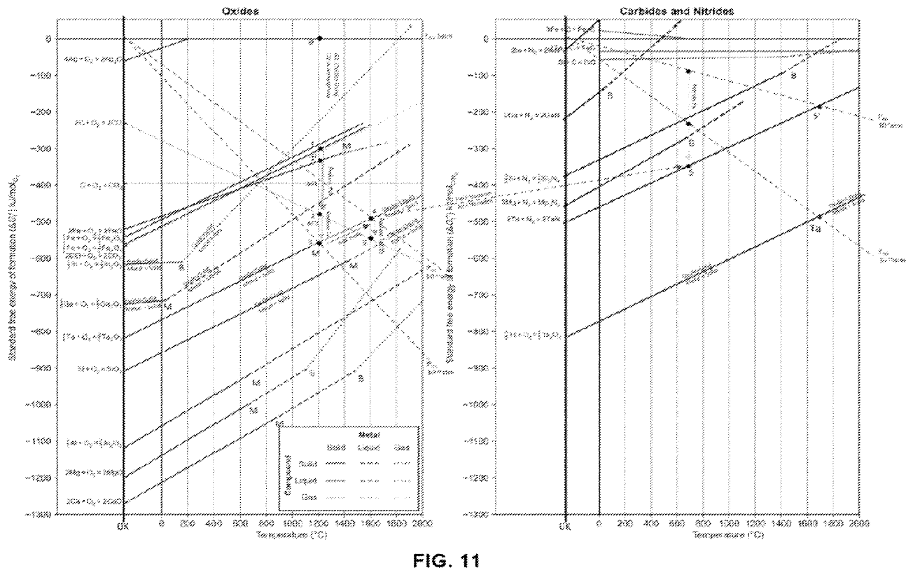

In one aspect, the disclosed reaction process includes three main reaction steps: (1) pyrolysis, (2) oxidation, and (3) carbothermal reduction (CTR) and nitridation, represented by a series of reactions shown in Equations 1-3. Equations 1A-B describe the pyrolysis step to drive off any organics and moisture that may be in the mixture. As a nonlimiting example, these organics can be in the form of plastics and paints. In a further aspect, it is also necessary to drive off the hydrogen at this step using a nitrogen purge under slight vacuum (0.01-0.1 Pa) about the sample. Further in this aspect, the bulk temperature can be kept below 500 °C. Without wishing to be bound by theory, by driving off hydrogen at this step, the formation of hydroxides later in the process is avoided. In one aspect, during the pyrolysis step, Ga and In can evaporate as demonstrated in other VMS studies. In an aspect, from FIG. 2A, for GaN, the temperature required to dissociate nitrogen can also be less than 2000 K (1727 °C) under slight vacuum. In a further aspect, the increased localized temperature during microwave irradiation can relax the need for slight vacuum. Tantalum pentoxide (Ta₂O₅) has a similar liquidus temperature as GaN as shown in FIG. 2B. In one aspect, because of this, both GaN and Ta₂O₅ can achieve a liquidus state at similar temperatures and not be surpassed during the pyrolysis stage. As shown in FIG. 11, the temperature for reduction of both GaN and Ta₂O₅ is not the same, and therefore the reduction will not start at a similar temperature. The reduction temperature is defined by the stability of CO relative to the metal oxide.

In another aspect, the second main step, following Equations 2a-e, is to perform an oxidation reaction to convert any residual In, Ga, and Ta into an oxide and to ensure full oxidation of Ta₂O₅. The pyrolysis stage can change the partial pressure of oxygen in Ta₂O₅. As seen in FIG. 2B, a lower oxygen concentration increases the liquidus temperature, requiring a greater temperature. In another aspect, during the oxidation step, magnetite (Fe₃O₄) microspheres that have been ball milled with the pyrolyzed phase can be introduced into the mixture. In a further aspect, the magnetite can act as a source of oxygen and exothermic energy to drive the reaction and enhance microwave absorption. In a further aspect, magnetite acts as a microwave sink, absorbing RF energy and converting to heat. In a still further aspect, enhanced absorption further increases the heating rate. It is noted that, in previously known processes, total energy requirements are not provided from a microwave source and additional, supplemental exothermic energy is required.

In one aspect, the third main step in the process is CTR with a nitridation process. In a further aspect, it is advantageous to achieve a nitridated final phase to purify, separate, and stabilize the key elements for recovery. In one aspect, purification can help remove arsenic, separation can help form a solid final solution, and nitridation can provide a final stable composition. In an aspect, it should be noted that iron does not form a nitride, as seen in other CTR studies, which provides additional evidence it can be easily separated. In one aspect, iron may oxidize from carbon dioxide, providing energy, and easily reused in step two. In one aspect, an additional step may include hydrogenation to drive off carbon in the form of methane. In an aspect, pure metals Ga, In, and Ta can form on the surface of the crucible or as metal sponge or in the form of nitride phases separate.

### Pyrolysis:

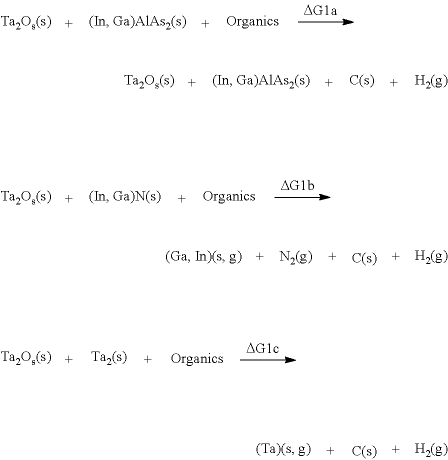

### Oxidation:

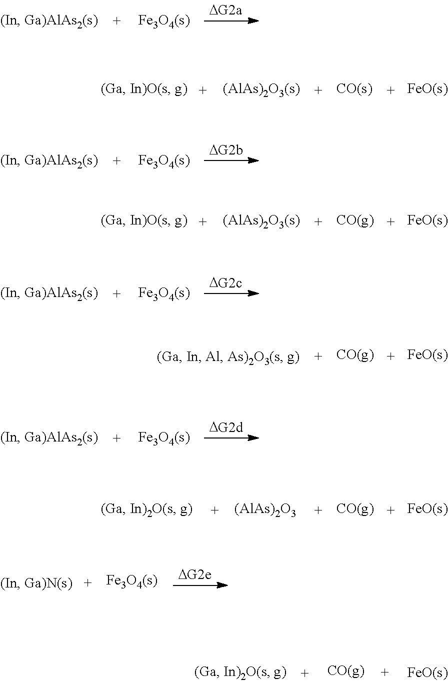

### Carbothermal Reduction-Nitridation:

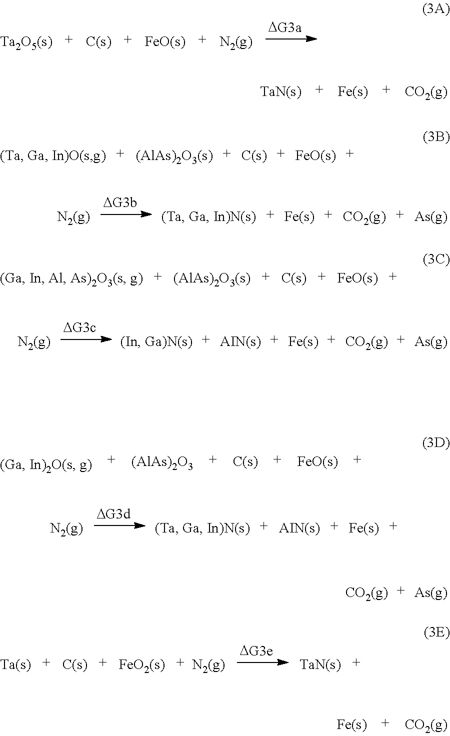

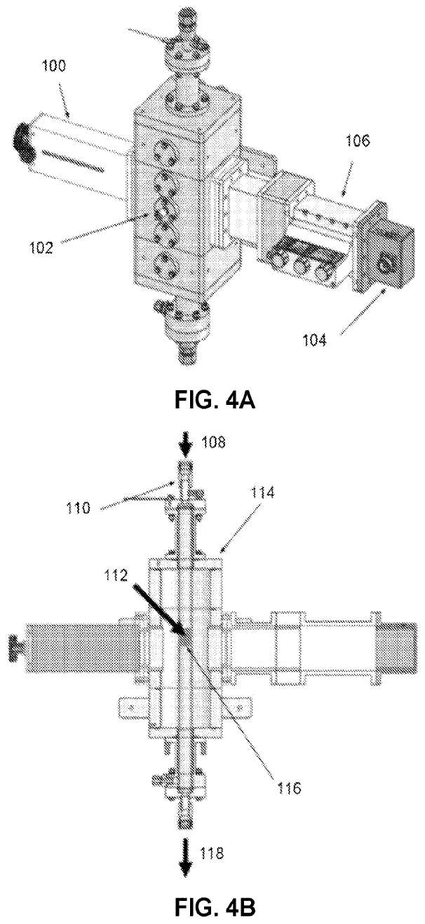

In one aspect, the 3 KW multimode microwave system illustrated in FIGS. 4A-4B is similar to a conventional microwave system used to heat food at home. In a further aspect, the microwave power is passed through impedance match waveguide into a low vacuum chamber. In a still further aspect, the microwave waves reflect off the chamber walls which can form regions of constructive and destructive interactions. In one aspect, this can result in regions within the chamber known as hotspots, making it often necessary to move or rotate the sample through the field to achieve uniform heating. In one aspect, once peak coupling with the e-waste has been achieved the sample is stopped from rotating. In some exemplary embodiments, the e-waste feedstock is placed within a sealed crucible to capture products. In one aspect, the microwave is turned off after each cycle and physical phase separation is used to remove select phases.

In any of these aspects, the evaporated species and condensed species can be analyzed at each reaction step (i.e. pyrolysis, oxidation, CTR). In an aspect, the in-situ temperature-time history can be monitored with a retrofitted shortwave infrared (IR) sensor that can transmit through quartz and alumina. In one aspect, various reactor configurations can be used to capture the evaporated or condensed phases more easily. In another aspect, alternate reactor configurations can also be employed to enhance microwave absorption through a resonant cavity. In another aspect, commercially available vacuum heat treating furnaces can be retrofitted with a microwave system to achieve a multimode microwave at larger scales.

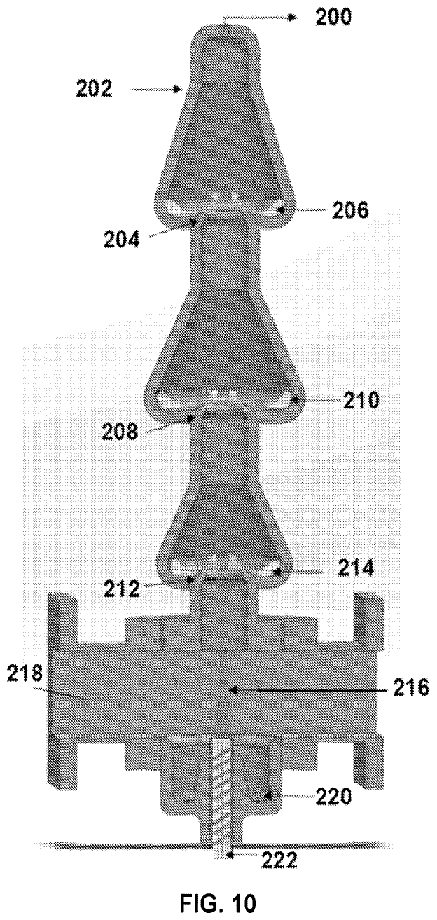

In one aspect, a single-mode microwave system is illustrated in FIGS. 4A-4B. In a further aspect, this system can achieve a standing wave across the same that is TE01 or TM01 or hybrid modes. In a still further aspect, the peak intensity of the wave can be precisely placed at the sample by adjusting the stub tuner and sliding short. In another aspect, this system provides precise control of the magnitude and phase of the electromagnetic wave and also allows for in-situ measurement of temperature-time history. In one aspect, the sample can be placed within a quartz tube that is transparent to the microwave. In a further aspect, the sample can evaporate and condense downstream of the sample on the walls of the quartz tube or within a hot trap that placed outside of the reactor. In any of these aspects, both the walls of the quartz tube and the contents of the hot trap can be analyzed using a variety of characterization techniques. In another aspect, a custom applicator can be used to capture evaporated, condensed, and sponge phases as shown in FIG. 10.

In at least one embodiment, disclosed herein is a process to recover ICT metals such as indium (In), gallium (Ga), tantalum (Ta), and copper (Cu) from e-waste using a high-efficiency microwave electro-driven approach. In a further aspect, e-waste feedstock is crushed via ball milling or a similar method. In a still further aspect, the crushed e-waste undergoes a pyrolysis method that utilizes microwave energy to pyrolyze the e-waste to drive off organics and leave carbon and other materials with high melting temperatures such as Ta behind. In yet another aspect, during the pyrolysis process, materials with low melting temperatures such as Ga and In may evaporate. In one aspect, the evaporation and subsequent condensation are temperature dependent and precisely controlled by the microwave power. In another aspect, at the end of pyrolysis the materials may be heating in atmospheric or oxidizing environment to form metal oxides. In another aspect, H₂O can be introduced after pyrolysis and microwave heated to aid in oxidation and drying material.

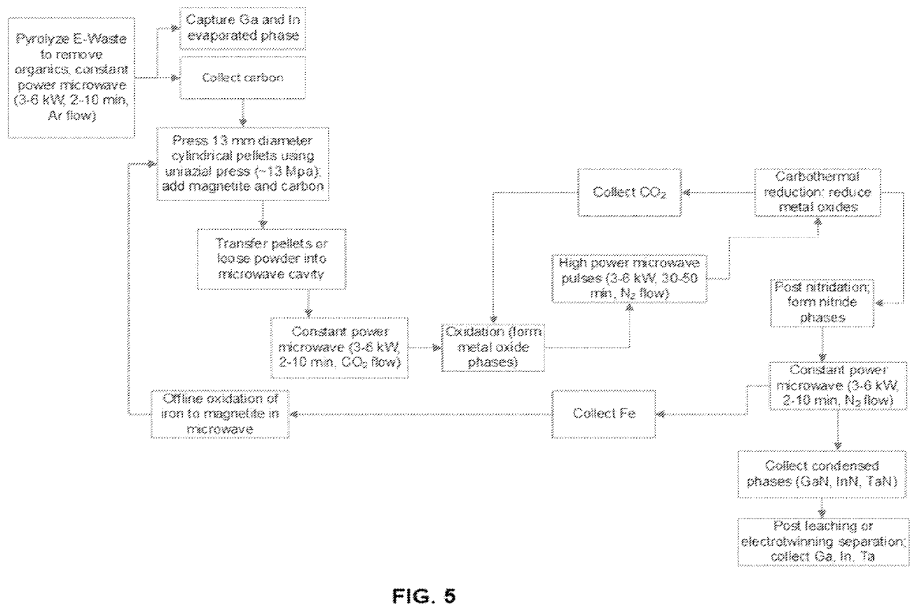

In another aspect, the microwave process also has the advantage of modifying the surface of the crushed e-waste, which has been shown to aid in the extraction of select elements which may encapsulated by other materials. In one aspect, the microwave breaks these agglomerates up in part due to the difference in thermal expansion and the local heating effect of microwave heating. In a further aspect, the next step then oxidizes the remaining e-waste after pyrolysis. In one aspect, to aid in the oxidation process, magnetite (Fe₃O₄) is combined with the e-waste to act as a source of oxygen and a microwave sink, since magnetite is an exceptional absorber of microwave energy. In another aspect, the microwave can be utilized again to provide heat and an oxidative environment. In a further aspect, the reduction of magnetite can also provide supplemental exothermic energy such that the microwave will not be responsible for providing the total energy to the system. In one aspect, as the magnetite reduces and converts to iron (i.e. Fe₃O₄ to Fe), oxygen is liberated and oxidizes any metals present (i.e., Ga becomes Ga₂O₃, In becomes InO, etc.). Further in this aspect, enough magnetite is then added to liberate oxygen but not fully reduce the magnetite. In one aspect, magnetite will partially reduce to iron oxide (FeO); a mixture of FeO and metal oxides are then present with the pyrolyzed carbon. In a further aspect, microwave energy is then significantly increased to achieve an extremely high ramp rate of temperature, which causes the metal oxides and carbon to vaporize. In another aspect, the vaporized species may be in a combination of plasma or gas phases and undergo a gas phase reaction, as opposed to a liquid-liquid, liquid-gas, or liquid-solid reaction. In any of these aspects, during this process, carbothermal reduction (CTR) occurs. In one aspect, oxygen from the metal oxides is liberated and combines with the available carbon in the system to form carbon monoxide (CO) and carbon dioxide (CO₂). In addition, CO is the dominant gas phase if the temperature is above 700 °C, below CO₂ is the dominant gas phase. In a further aspect, a slight vacuum will evacuate CO₂ from the system. In a still further aspect, the metal oxides are then reduced completely to metal and condense to a solid phase during the cooling down process. In one aspect, a post-nitridation process with the microwave is then used to convert the selected metal Ga, In, and Ta into GaN, InN, and TaN, respectively. In still another aspect, because iron does not form a stable bulk nitride or nitrate phase, the iron can be removed from the system. In one aspect, the iron can be reduced again without the microwave reactor to form magnetite to be reused in the overall process without e-waste present. FIG. 5 illustrates an example of the overall process.

### Methods for Copper Recovery

The overall process for copper recovery represents another application of a microwave reduction process. In one aspect, this process has shown success in the recovery of low-volume fractions of other critical elements, specifically Ga, In, and Ta from e-waste as described herein. In another aspect, success of this process lies in the utility of the microwave-sustained plasma and careful consideration of the process thermodynamics. In another aspect, the microwave process of leaded copper does not require a liquidus state to be achieved.

The advantage of the microwave is severalfold. In one aspect, the microwave couples well with carbon found in the e-waste feedstock, wherein the carbon is formed as a result of an e-waste pyrolysis process. Further in this aspect, when the organics in the e-waste scrap are digested, carbon or charcoal (char) is formed. In a further aspect, not only does the carbon couple well with the microwave, but the disclosed microwave reduction process utilizes the carbon and subsequently carbon monoxide as a reducing agent.

In an aspect, another advantage of the microwave approach is that relies on a local process that is self-limiting. In a further aspect, this is a result of the selective heat of the microwave and the localized exothermic reduction energy. In a further aspect, because temperature and pressure are controlled, the final state is self-limited once the carbon reaction is complete. In a still further aspect, this is a tremendous energy and carbon saving as it does not require achieving a bulk metal phase melting temperature.

In yet another aspect, an advantage of the microwave system involves the initiation and sustained CO plasma. In one aspect, the reaction energy for the conversion is a balance between the exothermic energy of the metal oxide reduction and the endothermic generation of the CO plasma. In another aspect, the majority of the energy is coming from chemical energy and the microwave simply is involved in initial heating, activation, and sustaining the plasma.

In one aspect, useful materials for the disclosed process are end products of an e-waste pyrolysis. In another aspect, e-waste pyrolysis can involve a primary reactor, secondary reactor, gas scrubbers, tar/oil crackers, and gas combustors, and can mitigate the toxic byproducts that are generated during the pyrolysis process of e-waste. In a further aspect, the byproduct of e-waste pyrolysis can be a mixture of carbon with metal and metal oxide fines. In one aspect, carbon turns out to be difficult to physically remove from the metal fines after pyrolysis and proves detrimental to other recovery processes such as hydrothermal methods (acid leaching). In a further aspect, these properties of carbon make it advantageous to use a pyrolysis by-product as a reducing agent for the disclosed ICT recovery process. In an additional aspect, the carbon can be fully removed from the material by processing at stoichiometric carbon ratios.

In one aspect, carbon can be removed from the system by controlling the partial pressure of oxygen. In another aspect, in the disclosed process, the reaction temperature can be controlled quickly and precisely. In some aspects, heating rates of 3000 °C/s can be achieved. In a further aspect, this rate is beyond what can be achieved from induction heating or even ohmic heating (flash joule heating). In a further aspect, this temperature control enables selective reduction of compounds such as, for example, in multiple-component e-waste. In one aspect, early targets can be the lower melting temperature compounds. In a further aspect, lead oxide can be selectively reduced using both the CO plasma and reduced copper metal. In a further aspect, once the lead is reduced, because of its low vapor pressure and precise control of partial pressures, the lead can evaporate and condense downstream. In yet another aspect, in the case of material with high metal solidus temperatures, this reduced metal can be collected as a metal sponge at the bottom of the reaction vessel.

In one aspect, the microwave heating approach avoids issues with electrical short circuiting of current during flash joule heating. In additional aspect, the microwave heating approach provide uniform heating of oxide materials that have intrinsically low electrical conductivities. In one aspect, microwave heating provides, more uniform heating that can scale to much larger reaction vessels.

In a further aspect, the disclosed selective refining process can recover copper from leaded copper e-waste at 10 kg/hr at 95% recovery at 85% purity. In another aspect, carbon utilization and energy utilization (MJ/ton Cu) can be reduced by fifty percent for the proposed process compared to the sulfide pyrothermal processing method.

In an additional aspect, useful materials for the disclosed process can be end products of an industrial waste refining process, wherein the industrial waste is comprised of components that contain commercially valuable metals or critical metals such that the useful materials result in critical metal oxides, critical metal carbides, critical metal chlorides, and/or critical metal nitrides by interacting with the principal microwave processing steps described earlier. The industrial waste may also contain components that contain organics or other carbon-containing or oxygen-containing components to help facilitate pyrolysis, oxidation, carbothermal reduction-nitrogen steps, or a combination thereof.

### Additional Process Parameters and Advantages

In some aspects, the at least one metal, metal carbide, or metal nitride can be recovered using the disclosed processes with at least 80% or greater purity, or at least 80%, 85%, 90%, 95%, or 99% or greater purity, or a combination of any of the foregoing values, or a range encompassing any of the foregoing values. In another aspect, at least 50% of the mass of the at least one metal is recovered from the electronic waste relative to the total mass of the metal in the electronic waste, or at least 50%, 60%, 70%, 80%, or at least 90% of the mass is recovered, or a combination of any of the foregoing values, or a range encompassing any of the foregoing values. In some aspects, at least 500 g of the at least one metal, metal carbide, or metal nitride can be recovered per hour per ton of electronic waste using the disclosed process.

In an aspect, depending on the metal, different compounds and forms of the metal can be recovered using the disclosed process. For example, tantalum can be recovered as TaC, Mn can be recovered as Mn₇C₃, gallium and indium can be recovered as GaN and InN, Ga₂O₃ and In₂O₃, or pure metals, respectively. In one aspect, when the metal is copper, the copper recovered can be substantially free of lead.

Various temperatures are contemplated for the process steps disclosed herein. In one aspect, pyrolyzing electronic waste can be carried out at from about 500 to about 900 °C, or at about 500, 550, 600, 650, 700, 750, 800, 850, or about 900 °C. In another aspect, oxidation can be conducted at from about 100 °C (i.e., in the presence of water as steam) to about 1100 °C, or at about 100, 150, 200, 250, 300, 350, 400, 450, 500, 550, 600, 650, 700, 750, 800, 850, 900, 950, 100, 1050, or about 1100 °C, or a combination of any of the foregoing values, or a range encompassing any of the foregoing values. In still another aspect, microwave heating of the oxidized composition can be conducted at from about 900 to about 1450 °C, or at about 900, 950, 1000, 1050, 1100, 1150, 1200, 1250, 1300, 1350, 1400, or about 1450 °C, or a combination of any of the foregoing values, or a range encompassing any of the foregoing values. In still another aspect, microwave heating of the oxidized composition can be conducted at a pressure of from about 15 inHg to about −27 inHg (about 381 mmHg to about −686 mmHg). In still another aspect, microwave heating of the oxidized composition can include localized heating, a self-limiting reduction reaction, or both, thus providing advantages in terms of lower power usage compared to standard pyrothermal processes.

In some aspects, following microwave heating of the oxidized composition, one or more additional processing steps such as, for example, an electrostatic processing step, a physical separation step, or both, can be carried out. In some aspects, separation does not require the at least one metal to transition to a homogeneous liquidus state at any point in the disclosed processes.

In an aspect, the microwave heating in any step can be applied with a microwave having a power of from about 1 KW to about 100 KW, or about 3 KW, or about 1, 5, 10, 25, 50, 75, or about 100 KW. In another aspect, the microwave heating in any step can be applied by a microwave with an operating frequency of from about 1 GHz to about 10 GHZ, or about 2.45 GHz, or about 1, 2, 3, 4, 5, 6, 7, 8, 9, or about 10 GHz.

In some aspects, the method can be used to recover at least one rare earth element such as, for example, scandium, yttrium, lanthanum, cerium, praseodymium, neodymium, promethium, samarium, europium, gadolinium, terbium, dysprosium, holmium, erbium, thulium, ytterbium, lutetium, or any combination thereof.

Many modifications and other embodiments disclosed herein will come to mind to one skilled in the art to which the disclosed compositions and methods pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of the appended claims. The skilled artisan will recognize many variants and adaptations of the aspects described herein. These variants and adaptations are intended to be included in the teachings of this disclosure and to be encompassed by the claims herein.

Although specific terms are employed herein, they are used in a generic and descriptive sense only and not for purposes of limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure.

Any recited method can be carried out in the order of events recited or in any other order that is logically possible. That is, unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided herein can be different from the actual publication dates, which can require independent confirmation.

While aspects of the present disclosure can be described and claimed in a particular statutory class, such as the system statutory class, this is for convenience only and one of skill in the art will understand that each aspect of the present disclosure can be described and claimed in any statutory class.

It is also to be understood that the terminology used herein is for the purpose of describing particular aspects only and is not intended to be limiting. Unless defined otherwise, all technical and scientific terms used herein have the same meaning as commonly understood by one of ordinary skill in the art to which the disclosed compositions and methods belong. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Prior to describing the various aspects of the present disclosure, the following definitions are provided and should be used unless otherwise indicated. Additional terms may be defined elsewhere in the present disclosure.

### DEFINITIONS

As used herein, “comprising” is to be interpreted as specifying the presence of the stated features, integers, steps, or components as referred to, but does not preclude the presence or addition of one or more features, integers, steps, or components, or groups thereof. Moreover, each of the terms “by”, “comprising,” “comprises”, “comprised of,” “including,” “includes,” “included,” “involving,” “involves,” “involved,” and “such as” are used in their open, non-limiting sense and may be used interchangeably. Further, the term “comprising” is intended to include examples and aspects encompassed by the terms “consisting essentially of” and “consisting of.” Similarly, the term “consisting essentially of” is intended to include examples encompassed by the term “consisting of.

As used in the specification and the appended claims, the singular forms “a,” “an” and “the” include plural referents unless the context clearly dictates otherwise. Thus, for example, reference to “a metal,” “a metal oxide,” or “an oxidizing agent,” including, but not limited to, mixtures or combinations of two or more such metals, metal oxides, or oxidizing agents, and the like.

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

When a range is expressed, a further aspect includes from the one particular value and/or to the other particular value. For example, where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less’ and should be interpreted to include the specific ranges of ‘about x’, ‘about y’, and ‘about z’ as well as the ranges of ‘less than x’, less than y′, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y′, and ‘greater than z’. In addition, the phrase “about ‘x’ to ‘y’”, where ‘x’ and ‘y’ are numerical values, includes “about ‘x’ to about ‘y’”.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the terms “about,” “approximate,” “at or about,” and “substantially” mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated ±10% variation unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

As used herein, the term “effective amount” refers to an amount that is sufficient to achieve the desired modification of a physical property of the composition or material. For example, an “effective amount” of an oxidizing agent refers to an amount that is sufficient to achieve the desired improvement in the property modulated by the formulation component, e.g. achieving the desired level of oxidation of the metal(s) of interest. The specific level in terms of wt % in a composition required as an effective amount will depend upon a variety of factors including the amount and type of metal to be oxidized, amount and type of oxidizing agent, microwave parameters, environment, and any carbon or other organic materials present in the composition to be oxidized. In one aspect, the oxidizing agent used herein can be magnetite, water, atmospheric oxygen, or any combination thereof. In another aspect, the oxidizing agent can be ball milled into microspheres prior to use in the disclosed process.

As used herein, the terms “optional” or “optionally” means that the subsequently described event or circumstance can or cannot occur, and that the description includes instances where said event or circumstance occurs and instances where it does not.

Unless otherwise specified, temperatures referred to herein are based on atmospheric pressure (i.e. one atmosphere).

Now having described the aspects of the present disclosure, in general, the following Examples describe some additional aspects of the present disclosure. While aspects of the present disclosure are described in connection with the following examples and the corresponding text and figures, there is no intent to limit aspects of the present disclosure to this description. On the contrary, the intent is to cover all alternatives, modifications, and equivalents included within the spirit and scope of the present disclosure.

### ASPECTS

The present disclosure can be described in accordance with the following numbered Aspects, which should not be confused with the claims.

Aspect 1. A method to recover at least one metal from electronic waste, the method comprising:
(a) pyrolyzing electronic waste, wherein the electronic waste comprises the at least one metal and one or more organic components, and wherein the pyrolyzing forms a composition comprising pyrolyzed electronic waste and pyrolyzed carbon;
(b) contacting the composition with an oxidizing agent and oxidizing the composition using microwave heating to form an oxidized composition comprising at least one metal oxide containing the at least one metal; and
(c) applying microwave heating to the oxidized composition, wherein the microwave heating causes carbothermal reduction, carburization, nitridation, or a combination thereof, to form the at least one metal, at least one metal carbide, or at least one metal nitride from the at least one metal or metal oxide.

Aspect 2. The method of aspect 1, wherein the at least one metal, metal carbide, or metal nitride is recovered with at least 80% or greater purity.

Aspect 3. The method of aspect 1 or 2, wherein at least 50% mass of the at least one metal is recovered from the electronic waste relative to a total mass of the metal in the electronic waste.

Aspect 4. the method of any one of aspects 1-3, wherein at least 500 g of the at least one metal, metal carbide, or metal nitride can be recovered per hour per ton of electronic waste.

Aspect 5. The method of any one of aspects 1-4, wherein the electronic waste comprises a tantalum capacitor, a transistors, a liquid crystal display (LCD), a light emitting diode (LED), a communications device, a satellite or component thereof, an aviation component, a high performance computing component, a vehicle electronic control module, a gallium nitride high electron mobility transistor, or any combination thereof.

Aspect 6. The method of any one of aspects 1-5, wherein the electronic waste is subjected to microwave heating in a sealed crucible.

Aspect 7. The method of any one of aspects 1-6, further comprising crushing the electronic waste to particles prior to pyrolyzing.

Aspect 8. The method of aspect 7, wherein the particles have an average diameter of less than about 1 mm.

Aspect 9. The method of any one of aspects 1-8, wherein at least a portion of the pyrolyzed carbon is produced from polymers, paints, a nonmetallic printed circuit board (PCB) component, or any combination thereof.

Aspect 10. The method of any one of aspects 1-9, wherein the at least one metal comprises an information and communication technology (ICT) metal.

Aspect 11. The method of aspect 10, wherein the ICT metal comprises indium, gallium, tantalum, copper, or any combination thereof.

Aspect 12. The method of aspect 11, wherein tantalum is recovered as TaC.

Aspect 13. The method of aspect 11, wherein nitridation is performed and wherein gallium is recovered as GaN, indium is recovered as InN, or both.

Aspect 14. The method of aspect 11, wherein manganese is recovered as Mn7C3.

Aspect 15 The method of aspect 11, where gallium is recovered as Ga2O3, indium is recovered as In2O3, or both.

Aspect 16. The method of aspect 11, where gallium and indium are recovered as Ga and In metal coatings on crucible walls.

Aspect 17. The method of any one of aspects 1-16, wherein the at least one metal comprises copper.

Aspect 18. The method of aspect 17, wherein the copper formed after step (c) is substantially free of lead.

Aspect 19. The method of any one of aspects 1-18, wherein pyrolysis is conducted using microwave heating, in a furnace, or any combination thereof.

Aspect 20. The method of any one of aspects 1-19, wherein hydrogen is driven off during step (a) using an N2 purge under slight vacuum.

Aspect 21. The method of any one of aspects 1-20, wherein step (a) removes residual moisture from the electronic waste.

Aspect 22. The method of any one of aspects 1-21, wherein during step (a), one or more low-melting temperature metals evaporate.

Aspect 23. The method of aspect 22, wherein the one or more low-melting temperature metals condenses to a solid state after evaporation.

Aspect 24. The method of aspect 22 or 23, wherein the one or more low-melting temperature metals comprise Ga, In, or any combination thereof.

Aspect 25. The method of any one of aspects 1-24, wherein step (a) is conducted at from about 500 to about 900 °C.

Aspect 26. The method of any one of aspects 1-25, wherein the oxidizing agent absorbs microwave energy.

Aspect 27. The method of any one of aspects 1-26, wherein the oxidizing agent comprises magnetite, H2O, atmospheric oxygen, or any combination thereof.

Aspect 28. The method of any one of aspects 1-27, wherein the oxidizing agent is present as microspheres.

Aspect 29. The method of any one of aspects 1-28, further comprising ball milling the oxidizing agent with the composition formed in step (a) prior to performing step (b).

Aspect 30. The method of any one of aspects 1-29, wherein under microwave heating, the oxidizing agent is reduced to a partially reduced oxidizing agent, and wherein presence of the partially reduced oxidizing agent increases temperature and causes the vaporization of one or more metal oxides and carbon.

Aspect 31. The method of any one of aspects 1-30, wherein step (b) is conducted at from about 100 °C to about 1100 °C.

Aspect 32. The method of any one of aspects 1-31, further comprising recovering iron following step (c) and oxidizing the iron with oxygen to reform the magnetite.

Aspect 33. The method of any one of aspects 1-32, wherein, in step (c), nitridation occurs when microwave heating is conducted in a nitrogen atmosphere.

Aspect 34. The method of aspect 33, wherein nitridation results in the formation of at least one metal nitride.

Aspect 35. The method of aspect 33 or 34, wherein the oxidizing agent does not form a stable nitride and is subsequently removed from the at least one metal nitride.

Aspect 36. The method of any one of aspects 33-35, further comprising a purification or separation step following the formation of the at least one metal nitride.

Aspect 37. The method of any one of aspects 1-36, further comprising a hydrogenation step after step (c) to drive off residual carbon as methane.

Aspect 38. The method of any one of aspects 1-37, wherein during step (c), at least one high-melting temperature metal is recovered as a metal sponge material.

Aspect 39. The method of aspect 38, wherein the at least one high-melting temperature metal comprises Cu, Ta, or any combination thereof.

Aspect 40. The method of aspect 38 or 39, wherein a stable carbide phase of the high-melting temperature metal is formed.

Aspect 41. The method of any one of aspects 38-40, wherein the stable carbide phase comprises TaC, Mn7C3, or any combination thereof.

Aspect 42. The method of any one of aspects 1-41, wherein step (c) is conducted at from about 900 °C and 1450 °C.

Aspect 43. The method of any one of aspects 1-42, wherein step (c) is conducted at a pressure of from about 15 inHg (381 mmHg) to about −27 inHg (−686 mmHg).

Aspect 44. The method of any one of aspects 1-43, wherein step (c) further comprises one or more additional processing steps.

Aspect 45. The method of aspect 44, wherein the one or more additional processing steps comprise an electrostatic processing step, a physical separation step, or any combination thereof.

Aspect 46. The method of any one of aspects 1-45, wherein one or more of steps (a), (b), or (c) is performed in an inert environment.

Aspect 47. The method of aspect 46, wherein the Inert environment comprises N2, Ar, or any combination thereof.

Aspect 48. The method of any one of aspects 1-47, wherein the microwave heating is applied by a microwave with a power of from about 1 KW to about 100 kW.

Aspect 49. The method of aspect 48, wherein the microwave heating is applied by a microwave with a power of about 3 kW.

Aspect 50. The method of any one of aspects 1-49, wherein the microwave heating is applied by a microwave with an operating frequency of from about 1 GHz to about 10 GHz.

Aspect 51. The method of aspect 50, wherein the microwave heating is applied by a microwave with an operating frequency of about 2.45 GHZ.

Aspect 52. The method of any one of aspects 1-51, further wherein the at least one metal comprises a rare earth element.

Aspect 53. The method of any one of aspects 1-52, wherein phase separation does not require the at least one metal to transition to a homogeneous liquidus state.

Aspect 54. The method of any one of aspects 1-53, wherein step (c) comprises localized heating, a self-limiting reduction reaction, or both.

### EXAMPLES

The following examples are put forth so as to provide those of ordinary skill in the art with a complete disclosure and description of how the compounds, compositions, articles, devices and/or methods claimed herein are made and evaluated, and are intended to be purely exemplary of the disclosure and are not intended to limit the scope of what the inventors regard as their disclosure. Efforts have been made to ensure accuracy with respect to numbers (e.g., amounts, temperature, etc.), but some errors and deviations should be accounted for. Unless indicated otherwise, parts are parts by weight, temperature is in °C or is at ambient temperature, and pressure is at or near atmospheric.

### Example 1: Reactor and Apparatus

A multi-mode microwave reactor was used in the studies presented herein. An exemplary microwave cavity can be seen in FIG. 1A. The microwave reactor used for these experiments was a 3 KW microwave with 2.45 GHz operating frequency and an 8 ft³ (about 227 L) cavity size. The insulation is microwave transparent and a pyrometer was placed outside the reactor. The shortwave length (0.9 μm) pyrometer can measure through insulation. Various configurations of sample package insulation were used around samples in an alumina crucible.

An exemplary reactor configuration (FIG. 4A) includes manual or automatic sliding short circuit 100, view ports 102 for process monitoring by a thermal camera or IR pyrometer, coaxial to waveguide input 104 for solid state or magnetron generators, and manual or automatic stub tuner 106. An exemplary reactor configuration 114 (FIG. 4B) includes a gas input (e.g. an N₂ input) 108, pressure caps 110 for down to −28 in Hg up to 300 psi operation and standard NPL process conditions. E-waste sample 112 is held in process tube 116 within a treatment zone of 30 mm (OD)×24 mm (ID)×550 nm in length. The system also includes external hot trap 118.

### Lab Scale Prototype

FIG. 10 is an illustration of a disclosed lab-scale recovery device. This device interfaces with the single-mode microwave system that is based on a 3 KW 2.45 GHZ microwave generator. The applicator that replaces the factory applicator is simply an aluminum applicator that holds a quartz tube. This can be replaced with a top and bottom applicator that interfaces with the factory waveguide. The top applicator will collect the evaporated and subsequently condensed phases and the bottom applicator will collect the agglomerates or metal sponge phases.

### Applicator Design

The current results of the process presented in the previous section relied upon a large multimode microwave system. Based on these results of both the determination of the evaporated and condensed phases, a prototype system has been developed that can collect both of these phases. To be more specific, as seen in Table 3, In and Ga will be recovered in the form of evaporated phases and Mn and Ta will be recovered in the form of metal sponge-type phases. FIG. 10 is a concept to collect both of these phases. The evaporated phases will be collected in the top portion and the condensed metal sponge phases will be collected in the bottom portion.

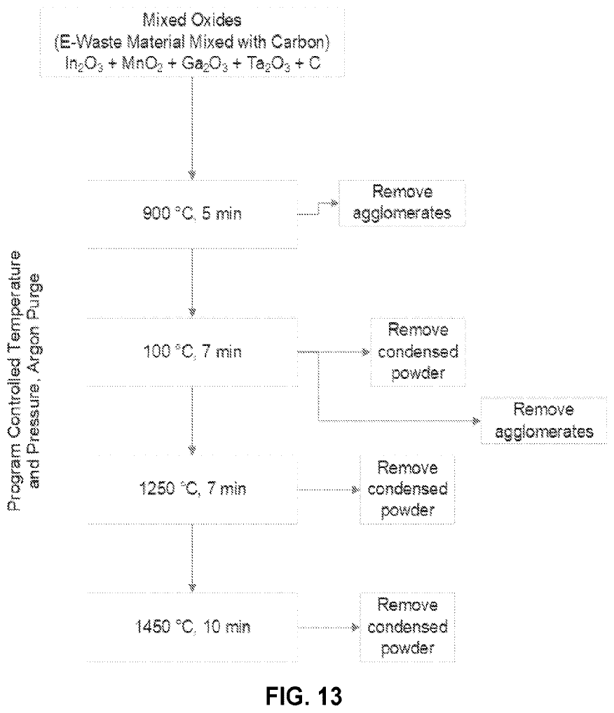

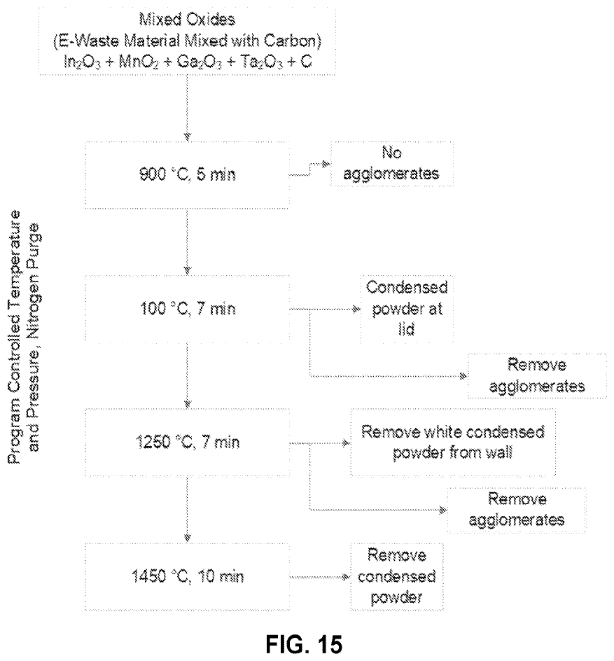

As seen in FIG. 10, the e-waste material will be fed from below using an auger-type system to bring the e-waste into the waveguide section. The e-waste will be contained with an inert gas purge under a vacuum, as was done in the multi-mode system. Either Ar or N₂ will be used as the gas. The e-waste will be subjected to programmed heating as outlined in FIGS. 13 and 15. The auger will proceed to provide a continuous feed of material.

The top and bottom portions that will collect the products will be printed using metal using an additive approach. The body of both applicators will be cooled with internal passages containing a flow of water. Plasma will be struck within the single mode system similar to the multimode system, which will significantly heat the upper portion compared to the lower portion of the custom applicator. Gases of Ar and N₂ may be also purged in the upper portion to help with the cooling and condensation so that the condensation does not happen on the wall of the wall. Both the condensed phases will be removed using a vacuum system that will be continually running.

The single-mode system outlined above will allows a more systematic approach to the recovery process. Custom applicators can also be integrated with the disclosed single-mode system.

### Demonstration of Recovery Hardware

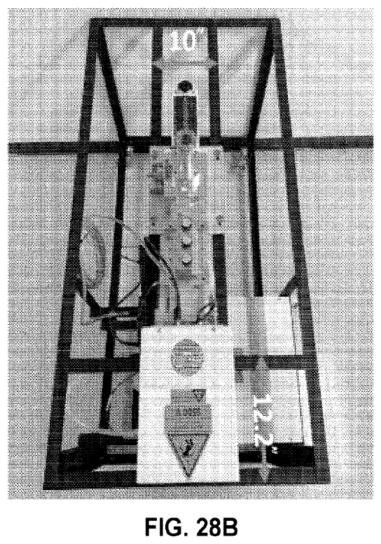

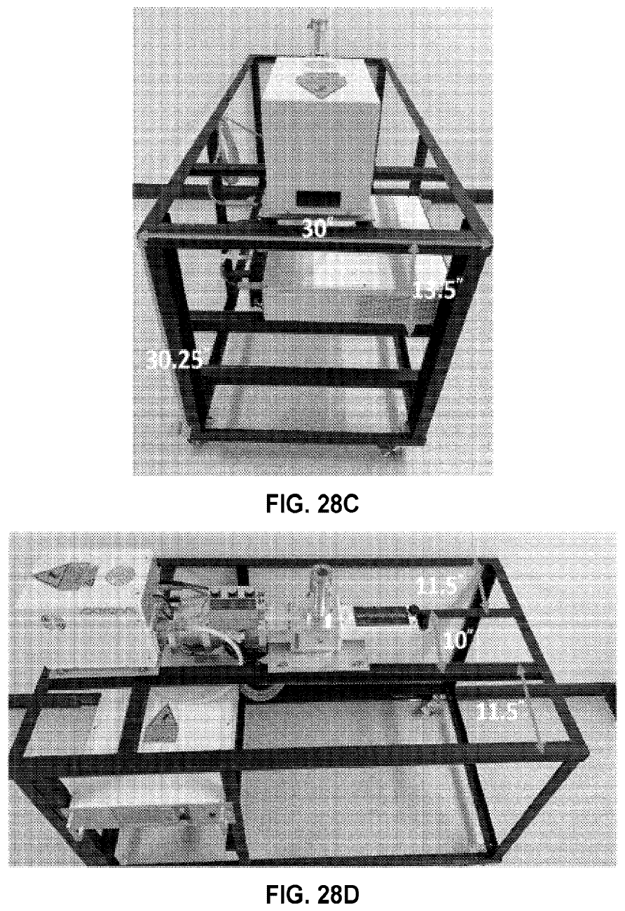

The recovery hardware system is a compact mobile unit on wheels that has a footprint of approximately 30 in. in width and 60 in. in length as shown in FIGS. 28A-28D. but a smaller size is also envisioned. The main component is the microwave generator, which has a dimension of 10 in. by 12 in. Below the microwave generator is the microwave power supply. To the right of the microwave generator is the microwave applicator. This microwave applicator holds the sample. The sample is contained within a quartz tube. A wool plug is placed within the quartz tube and the sample is filled on top of the wool. A variation is to place a small alumina crucible within the quartz tube. The quartz tube, which is approximately 20 in. in length is fed into the applicator section from below. The sample sits within the waveguide section. Either end of the quartz tubes is interfaced with a compression fitting that couples to the KF-25 vacuum fitting. The KF-25 fitting connects to a vacuum pump below and the condenser section above. The condenser section is used to collect the evaporated species. The temperature of the condenser is precisely controlled using a chiller. Situated at the very top of the condenser is a KF-40 tee that has an optical window for the IR camera (pyrometer) to measure the temperature of the sample. The other end of the KF-40 tee has a fitting for the introduction of different gas atmospheres. This setup provides a simple setup for proof of concept of the recovery hardware.

### Design of Microwave Applicator

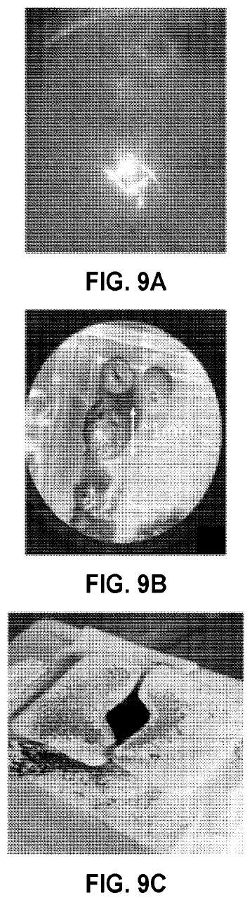

As discussed in the previous section the processing of the e-waste involves a series of downstream evaporated phases to be condensed and collected, along with metal sponge phases remaining after the reduction process. Examples of these phases are shown in FIGS. 9B-9C. The proposed plan is to design a microwave applicator that can be integrated onto a single-mode microwave unit. The microwave system that includes the microwave source, tuner, and waveguides will utilize off-the-shelf components designed by Sairem. Applicators were designed to interface with the WR340 waveguide (assuming 2.45 GHZ). FIG. 10 is an illustration of the prototype device that will be optimized and fabricated. The device consists of a top condensing unit 202 and a bottom collecting unit. The e-waste feedstock material is fed from below using an auger-type feed system 222 contained within an alumina or quartz tube. The microwaves that are within the waveguide 218 interact with the topmost surface of the e-waste material that enters the waveguide. Plasma 216 is sustained and evaporated phases, such as vaporized lead, are propelled upward due to buoyancy forces into the upper condenser unit. Within this unit, cold gases (ex: Ar, N₂, O₂, NH₃Cl) purge the evaporated phases through gas injectors 204, 208, and 212 causing rapid condensation and collection of the phases. A vacuum system 200 maintains a vacuum on the system and removes the condensed phase powders 206, 210, and 214. Depending on the density of the condensed phase they will collect at different levels of the top condenser 202. Lower density phases will collect on upper stages and high density will collect on lower. It may be necessary to only have one level and the complexity of multiple levels may not be necessary. The bottom portion of the custom applicator that sits below the waveguide collects the metal sponge material 220. A vacuum will extract these metal sponge phases for further processing.

The approach will be to utilize 3D metal printing to fabricate the custom applicators. Either an Incone718 or a high-conductivity copper alloy can be used. Direct metal laser melting such as the GE Concept Laser is the most likely type of machine that will be utilized.

The ability to utilize 3D printing will allow quick iteration of designs. It can also be integrated into water cooling chambers, gas channels, and vacuum lines into the part. Moreover, materials such as Inconel, which can withstand the high-temperature corrosive environment may be necessary.

### Example 2: Thermodynamics and Theoretical Considerations

### Thermodynamics of Ta Refinement

To determine the thermodynamics of the reaction density functional theory and JANAF-NIST thermodynamic databases were relied upon to determine the thermodynamic properties of the reaction. Significant effort was put into generating the Ellingham diagrams (ED), which are pivotal to visualizing the thermodynamic process and determination of the reduction temperatures and pressures. As outlined in Equations 1A-3A, the process for refining Ta involves four major steps, 1) pyrolysis, 2) oxidation, 3) carbothermal reduction/nitridation, and a final 4) purification. During the pyrolysis step, the approach will be to convert any organics in the mixture to carbon or hydrogen. The carbon will remain, and the hydrogen will be driven off into the surrounding atmosphere. This can be done using existing technology or in the microwave. However, the energy savings often do not out weight the required treatment of off-gases from this pyrolysis process. The next step, an oxidative (roasting) step will be to form all the metals in the e-waste mixture into their oxides. This means, specifically, converting Ta to Ta₂O₅ as seen in Equation 2A. This is the first step in purifying the metals. To aid in determining the thermodynamics of this reaction the Ellingham diagram shown in FIG. 11 was produced for this study. This figure exists for refining many oxides and is a widely used diagram, but it was required to be generated for select elements, especially Ta₂O₅. When reading the diagram, all thermodynamic values are a reference to the standard state, 298K and 1 atm. Furthermore, the major assumption is that entropy dictates the slope of the lines. The latent heat of formation is not considered at phase changes. This is an assumption because, at these high temperatures, the entropy is the main contributor to the Gibbs energy, which ultimately governs the reaction. The ED is a good way to relatively compare the stability of different oxides and their associated Gibbs energies. It can also be gathered at what temperature and what partial pressure of O₂ or N₂ the reactor should be kept at to evolve certain reactions.

As seen in FIG. 11, the formation enthalpy at OK is defined as the y-intercept. For Ta+O₂=Ta₂O₅, the enthalpy (ΔH) is approximately −818 KJ/mol. The relative position on the Ellingham diagram with respect will determine if one oxide or metal will be reduced or oxidized. In the case of oxidation, there are two approaches, and it will depend on the reaction kinetics which one is best. As noted in Equation 2A the proposed approach was to use a reducing agent to aid in the reduction of Ta→Ta₂O₅. This means that the curve in the Ellingham diagram must be high than the other curve. Magnetite (Fe₂O₃) was chosen as the reducing agent. Once magnetite is reduced it can be used as a getter for other impurities in the e-waste mixture. The next step in the process is to conduct a carbothermal reduction of the oxidized Ta₂O₅ materials. Followed by a subsequent nitridation, where TaN will be in a stable phase. At this point, the TaN can be handled in the atmosphere. The final step of the process will be a reduction of the TaN where the partial pressure of the N₂ atmosphere can be controlled to drive the reduction process.

Pyrolysis (microwave heat <300 °C):

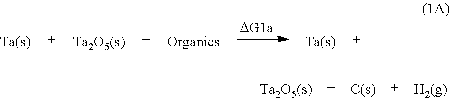

Oxidation (microwave heat at 1200 °C, vacuum Ar mix with P_{O2} of 10⁻¹⁵ atm):

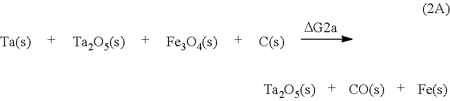

Carbothermal reduction/nitridation (microwave heat at 1600 °C, vacuum Ar mix with P_{O2} of 10-15 atm, hold, introduce N₂ at P_{N2} of 10⁻⁴ atm):

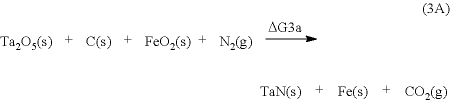

Purification (microwave heat at 900 °C, microwave Ar Par of 1 atm):

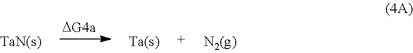

In addition to visualizing the thermodynamics of the reaction in the Ellingham diagram, the diagram also provides an indication of the temperatures that the process needs to carry out and the partial pressures. In the case of oxidation, in FIG. 11 (left), the partial pressure of oxygen is indicated by a negatively sloped line. The point where these lines intersect the reaction is the equilibrium point, where the partial pressure in the oxide balances with the partial pressure in the atmosphere. This is where vacuum reduction sees its utility. The Ellingham diagram indicates that almost all oxides can be reduced if they can be held at an elevated temperature above the point of intersection with the partial pressure lines. The piece of thermodynamics that is missing from this description is the reaction rate. Often this could take a long time, especially in solid materials. For example, Ta₂O₅ does not have a melting temperature until 1400 °C. At this temperature a partial pressure of 10-12 atm of O₂, which is a pretty low O₂. To avoid this slow kinetics of using the atmosphere to aid in the reduction, the approach will be to use a reducing agent, as mentioned above. The partial pressure of the atmosphere will still be used as a means of holding a processing state.

Similarly, FIG. 11 (right) is for the nitrides phases. The thermodynamic states from the left graph can be related to the right graph. The main difference is that the N₂ partial pressure is visualized as a downward sloping lines. This means the partial pressure of nitrogen can be used to either nitride or reduce a given state. The approach will be to convert the Ta to a stable TaN state. TaN is a more noble state than Ta. From here the TaN can be reduced by refining by putting back into a microwave system with a vacuum and lower partial pressure of N₂. There are other methods such as reducing under hydrogen gas but this is often avoided to avoid the reaction of hydroxides such as TaOH. Moreover, TaN can be refined using electrolysis methods to reach ultra-high purity.

### Thermodynamic Energy Consumption of Process

An estimate of the thermodynamic process can be determined based on the Gibbs energy of the reaction outlined in FIG. 11. It is assumed that Fe₂O₃ is provided, and no energy was required to produce magnetite. Table 1 outlines the energy requirements. The Ellingham diagram provides a quantitative and qualitative measure of reaction thermodynamics. For this discussion, the oxidation reaction will serve as starting point. The three lines of interest correspond to Equations 5A, 6A, and 7A. The Gibbs energy of these reactions is found at points 1, 2, and 3 on the Ellingham diagram at 1200 °C. The approach, as mentioned above, is to reduce the iron oxide, then use the freed oxygen to oxidize Ta metal. The Ellingham diagram illustrates that is possible because the line associated with Equation 5A to zero (more vertical) than Equation 5A. This means that Fe is more stable than Ta. Or Ta₂O₅ is more stable than Fe₃O₄. In this scenario, iron is acting as the reducing agent.

To determine the overall energy to conduct the oxidation reaction the values from the Ellingham diagram and the added energy from heat additions can be used. Everything will be referenced in terms of moles of O₂ and positive Gibbs energies will be assumed to be heat addition while negative Gibbs energies will be assumed to be heat generation. The process starts by heating the mixture from 20 °C to 1200 °C. The microwave will be used to input this heat at the cost of 6.5e5 KJ/kg, where kg is the total reactant mass. Two moles of O₂ are required, which equates to +1.30 MJ/kg of O₂. Next, Equation 6A must be subtracted from 5A to determine the Gibbs energy for the reduction of Fe₃O₄ to Fe. This value is approximately +145.4 KJ/mol of O₂ or +4.5 3 MJ/kg of O₂. The co-reduction Gibbs energy can be determined by taking the difference between 7A and 6A. This is an exothermic reaction that will generate heat. The Gibbs energy of the reduction is −86.4 KJ/mol of O₂ or −2.7 MJ/kg of O₂. The next step will be to add heat to the system to increase the temperate from 1200 °C to 1600 C at 1 mole addition of O₂. A heat addition of +260 KJ/kg of O₂ is required. Finally, the reduction of Ta₂O₅ to Ta. By subtracting Equation 9A from 8A, approximately −58.9 kJ/kg of O₂ is obtained. This is −1.84 MJ/kg of O₂. By the end of the oxidation, the total energy required is +1.55 MJ/kg O₂ which is required to complete the oxidation. This means additional energy needs to be added to the system.

Oxidation (microwave heat at 1200 °C, vacuum Ar Mix-P_{O2} at 10-15 atm):

$$\frac{1}{2} {Fe}_{3} {O}_{4} ( s ) {\to }^{Δ G} \frac{2}{3} Fe ( s ) + {O}_{2} ( g ) \qquad ( 5 A )$$

$$2 C ( s ) + {O}_{2} ( g ) {\to }^{Δ G} 2 CO ( g ) \qquad ( 6 A )$$

$$\frac{4}{5} Ta ( s ) + {O}_{2} ( g ) {\to }^{Δ G} \frac{2}{5} {Ta}_{2} {O}_{5} ( s ) \qquad ( 7 A )$$

Reduction (microwave heat at 1600 °C, vacuum Ar Mix-P_{O2} at 10-15 atm):

$$2 C ( s ) + {O}_{2} ( g ) {\to }^{Δ G} 2 CO ( g ) \qquad ( 8 A )$$

$$\frac{2}{5} {Ta}_{2} {O}_{5} ( s ) {\to }^{Δ G} \frac{4}{5} Ta ( s ) + {O}_{2} ( g ) \qquad ( 9 A )$$

Purification (microwave heat at 700 °C, microwave Ar Mix-P_{N2} at 10-4 atm):

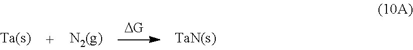

If the process is taken a step further and the reduced Ta metal is nitride by reacting with nitrogen as a slightly elevated temperature (700 °C) there is an exothermic generation of heat of approximately 7.95 MJ/kg. This means the reaction shift to a total reaction that is heat positive. It might be able to move this reaction non-sequentially by introducing nitrogen near the time of Ta reduction. Table 1 is a summary of all the reaction energy for the refinement of Ta.

TABLE 1
Energy Audit of Ta Refinement^{a}

| Reaction/Item | Specific Energy | |
|---|---|---|
| Heating (20 °C to 1200 °C) | 3.58 | MJ/kg O₂ |
| Reduction of iron | −4.54 | MJ/kg O₂ |
| Oxidation of Ta | −2.7 | MJ/kg O₂ |
| Heating (1200 °C to 1600 °C) | 0.88 | MJ/kg O₂ |
| Reduction of Ta | −1.84 | MJ/kg O₂ |
| Total before Nitriding | +4.47 MJ/kg O₂ = 0.79 mJ/kg Ta | |
| Nitridation of Ta | −9.02 | MJ/kg O₂ |

| | |
|---|---|
| Total | −4.55 MJ/kg O₂ = −0.81 mJ/kg Ta |

^{a}Resistive heating and adiabatic conditions are assumed. Before nitriding, energy must be added to the system. After nitriding, there is excess heat. The value for steel making using the pyrothermal method is 9.8 MJ/kg from iron ore and 2.5 mJ/kg from scrap iron.

Historically, in the steel hydrometallurgy process, these theoretical energy audits are approximately 20% more than the predictions. A realistic steel making process of hot metal is on the order of 10 MJ/kg. Ignoring the nitriding process, a 20-40% increase to 0.79 MJ/kg theoretical prediction might realistically be expected in Table 1. This equates to a realistic 1.1 MJ/kg of Ta. The other real advance is that scrap material is used instead of ore. The steel industry sees about a four-time decrease in energy when using scrap compared to ore. This is because of the decreased reduction requirement. This same advantage is seen when recycling capacitors because of the constitutive materials being Ta metal with a thin dielectric of Ta₂O₅ and MgO.

### Overview of Ta Refining Process

The refining process proposed here is similar to that of other pyrothermal metallurgy processes. As seen in FIG. 11, the process relies upon evaporating phases out of the e-waste feedstock and using phase separation to collect impurities. An approach being taken herein is to use Fe as the reducing agent in addition to using Fe as a getter of impurities. Often Fe is plagued by these impurities such as Si, Mg, and Ag but can be advantageous in the present case. Moreover, Ta does not form stable phases with many of these elements. Therefore if these phases can be segregated away from Ta, Ta can be purified. The additional step included here is a post-nitridation. This is actually a common practice in refining Ta. TaN is a stable phase that can be used advantageously to achieve a stable state in the atmosphere. TaN can subsequently be reduced under heat and vacuum. The only hurdle in this process is that often Ta and TaN remain solid at the temperature of interest. This means longer diffusion times may be required. Or a rotary kiln or such an apparatus might be necessary to speed the reaction. One positive of the microwave approach seen in previous studies is that the microwave improves diffusion. This has been seen to improve the reaction rates in other reactions under the microwave. This is actually an area that has not been heavily investigated but certainly warrants further study. The additional area that microwaves can change what is presented in the Ellingham diagram is by changing the localized partial pressures. It is known that microwaves create extreme local temperatures. This can cause highly decreased partial pressure of O₂, driving a local reduction process. This could be seen in the Ellingham diagram by a counter-clockwise rotation of the lines about a point of intersection. This can also be thought of as changing the entropy of the reaction or causing more localized mixing.

### Thermodynamics of In and Ga Refinement

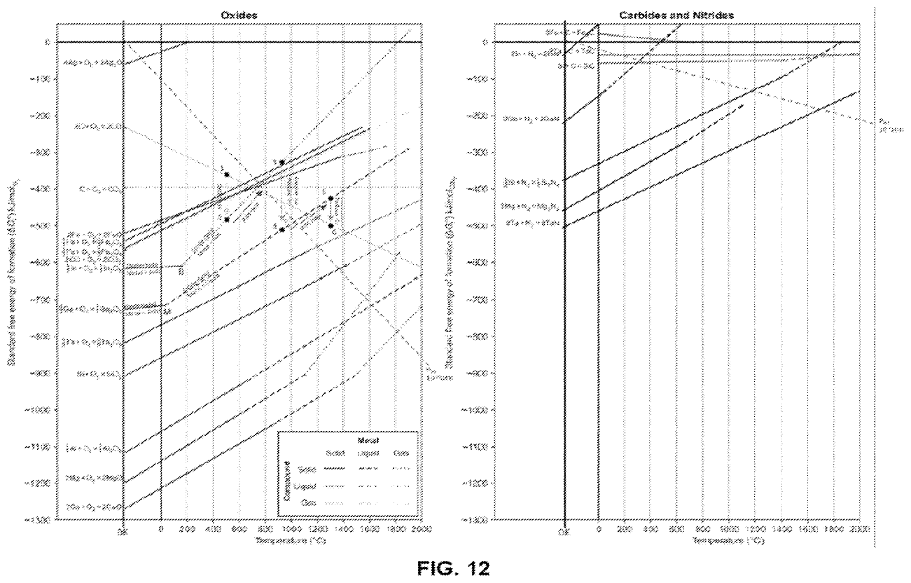

The Gibbs energy of In and Ga have been included in the Ellingham diagram of FIG. 11 and the specific reaction routes are proposed in FIG. 12. An important aspect of these materials to consider is the melting (labeled with M) and the boiling point (labeled with B) in the figure. Ga melts at 32 °C (305K) and In boils at 156 °C (430K). Gallium does not boil until 2203 °C. This potentially helps the refinement process when compared to Ta processing. The approach will be to oxide both In and Ga to their oxides, In₂O₃ and Ga₂O₃. This can be done with CO gas, which is formed from the oxidation of carbon with oxygen. In this process, CO or CO₂ will need to be introduced into the reactor vessel, or oxygen will need to be provided. Assuming CO is introduced into the reactor as a gas. A similar procedure can be used as done for Ta above to determine the reaction energies. The reaction is listed in Equations 11A through 18A. In this approach, refining of In and Ga at the same time is attempted. By happenstance, there is some energy to be saved between Equation 14A and 16A. The oxygen from the indium reduction can be used to oxidize the gallium. The total energy outlined in Table 2 decreased to the current value of 1.35 MJ/kg from 4.66 MJ/kg if the two processes are not combined. This is pretty significant energy savings.

Oxidation (microwave heat at 500 °C, vacuum Ar Mix-P_{O2} at 10⁻⁴ atm):

$$2 C ( s ) + {O}_{2} ( g ) {\to }^{Δ G} 2 CO ( g ) \qquad ( 11 A )$$

$$\frac{4}{3} In ( s ) + {O}_{2} ( g ) {\to }^{Δ G} \frac{2}{3} {In}_{2} {O}_{3} ( s ) \qquad ( 12 A )$$

Reduction (microwave heat at 900 °C, vacuum Ar Mix-P_{O2} at 10⁻²⁰ atm):

$$2 C ( s ) + {O}_{2} ( g ) {\to }^{Δ G} 2 CO ( g ) \qquad ( 13 A )$$

$$\frac{2}{3} {In}_{2} {O}_{3} ( s ) {\to }^{Δ G} \frac{4}{3} In ( s ) + {O}_{2} ( g ) \qquad ( 14 A )$$

Oxidation (microwave heat at 900 °C, vacuum Ar Mix-P_{O2} at 10^{31 20} atm, save carbon by using O₂ from Ga reduction):

$$\frac{4}{3} Ga ( s ) + {O}_{2} ( g ) {\to }^{Δ G} \frac{2}{3} {Ga}_{2} {O}_{3} ( s ) \qquad ( 16 A )$$

Reduction (microwave heat at 1300 °C, vacuum Ar Mix-P_{O2} at 10⁻²⁰ atm):

$$2 C ( s ) + {O}_{2} ( g ) {\to }^{Δ G} 2 CO ( g ) \qquad ( 17 A )$$

$$\frac{2}{3} {Ga}_{2} {O}_{3} ( s ) {\to }^{Δ G} \frac{4}{3} Ga ( s ) + {O}_{2} ( g ) \qquad ( 18 A )$$

### Overview of Ga and In Refining Process

The best approach for recovering Ga and In is through a combined process because the In reduction and the availability of additional Gibbs energy and oxygen can be harnessed. This avoids the necessity of reacting Ga with CO to liberate O₂. In this case, Ga becomes the reducing agent. This is analogous to why iron was incorporated in the Ta refining process. As seen in Table 2 the overall thermodynamic requirements still require some external energy at approximately 0.62 MJ/kg of Ga. This energy will be provided in the form of heat from the microwave source. In comparison to steel refining, this is significantly less energy-demanding. This stems from the thermodynamics visualized in FIG. 12 and because the temperature to drive these reactions are fairly low. In terms of In the reaction temperature is 500 °C than 900 °C. Gallium is 900 °C up to 1300 °C. It might be necessary to do a final nitriding step on Ga but In metal is fairly noble and does not require nitriding. In addition to nitriding, it is also possible to remove impurities by using any materials below In and Ga on the Ellingham diagram. However, because both In and Ga undergo a phase change at low temperatures, phase separation might be all that is necessary to achieve the desired purity levels.

It is hypothesized that the diffusional process will increase with microwaves. This same claim was made above in the case of Ta. Similarly, the microwave may drive some non-equilibrium partial pressures which can be visualized as a counter-clockwise twisting of ED lines. This can be advantageous as this will in turn increase the Gibbs energy during the exothermic oxidation process.

TABLE 2
Energy Audit of Ga and In Combined Refinement Process^{a}

| | |
|---|---|
| Reaction/Item | Specific Energy |

| | | |
|---|---|---|
| Heating (20 °C to 500 °C) | 1.47 | mJ/kg O₂ |
| Oxidation of In | −3.81 | mJ/kg O₂ |
| Heating (500 °C to 900 °C) | 2.08 | mJ/kg O₂ |
| Reduction of In₂O₃ | 3.31 | mJ/kg O₂ |
| Oxidation of Ga | −5.51 | mJ/kg O₂ |
| Heating (900 °C to 1300 °C) | 1.23 | mJ/kg O₂ |
| Reduction of Ga₂O₃ | −2.58 | mJ/kg O₂ |

| | |
|---|---|
| Total | 1.35 mJ/kg O₂ = 0.62 mJ/kg Ga |

^{a}Resistive heating and adiabatic conditions are assumed. Requirements for refining Ga and In are significantly lower than for Ta refining.

FIG. 13 is an illustration of the process flow chart for the fractional recovery of e-waste mixed with carbon. The process starts with a mixture of oxides that have been roasted using external pyrolysis and subsequent roasting process. The pyrolysis process converts all organics to carbon, which remains in the mixture. All other materials are converted to oxides using a roasting process where the metal fines are exposed to an oxygen atmosphere and oxidized. Using this knowledge, a surrogate material has been developed that is a mixture of metal oxides and carbon.

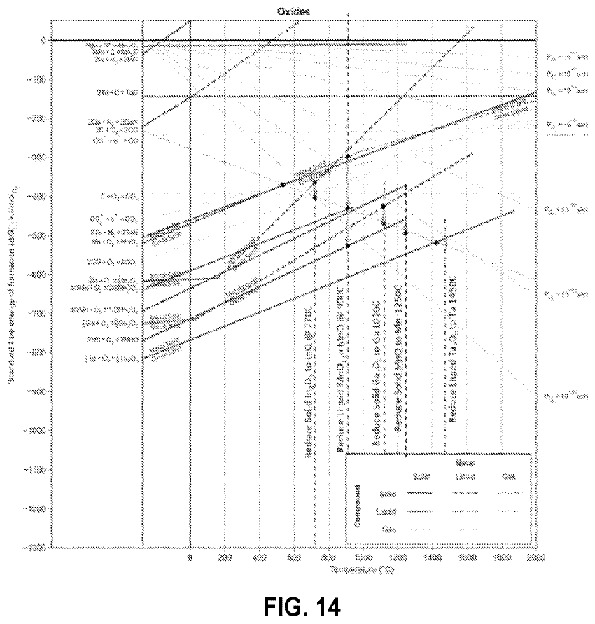

For this study, the volume fraction has been kept high. Amounts are as follows: 1 g Ta₂O₅, 0.5 g MnO₂, 0.5 g In₂O₄, 0.5 g Ga₂O₃, and 0.45 g carbon. This mixture becomes a black powder with white/yellow oxides powders. The processing step currently consists of four temperatures that are held between 5 and 10 minutes. These processing steps were determined previously and represented here in FIG. 14. These processing temperatures are based on the Ellingham Diagram presented in FIG. 14. Additionally, the partial pressure is maintained by pulling a vacuum to 10⁻² atm and then purging with Argon gas to reach a desired partial pressure of O less than 10⁻¹⁵ atm. The vacuum is re-pulled to 10⁻² atm with the purged Ar atmosphere. The decreased pressure aid in maintaining the plasma during the reaction. It was determined that the majority of the energy to evolve the reaction is actually coming from the exothermic energy of the reaction. The microwave is used to initiate the reaction and then to maintain the plasma. This is a fairly significant finding as it points to the fact that the microwave generator does not need to be outrageously large in terms of total power and the overall economics of the process become competitive with other processes. The real advantage of the microwave process is twofold, 1) selective reduction of elements and 2) use of the carbon that is coming from the pyrolysis of organics in the e-waste. The latter, utilization of carbon is advantageous in the recycling process because carbon typically needs to be removed or it will impede other recycling approaches. The former is maybe the more significant of the two advantages. Because the microwave selectively heats the e-waste, and more specifically, the carbon, forming carbon monoxide when it reacts as with the oxygen in the oxide, the reaction is actually self-limiting. Once the metal oxide has been reduced to the raw metal the region in the vicinity of the reaction vessel stops. It is also seen that the microwaves do not couple with the metal either. The reduced metal actually reflects microwaves because of the abundance of free electrons in the material. This is another huge finding from these studies.

### Example 3: Feedstock and Pyrolysis Process

The proposed process that has been developed is integrated with a digester pyrolysis process that will convert all of the organic material (paints, polymers, etc.) from the e-waste packaging into carbon. This same process also grinds and crushes the e-waste material and does a roasting process on the metals within the e-waste. This means all the metal fines are converted to their respective stable oxides. This means Ta will be converted to Ta₂O₅, Ga will be converted to Ga₂O₃, and In will be converted to In₂O₃. These oxide phases will be a fine powder that is mixed with pyrolyzed carbon. The carbon is effectively a char-like carbon. Very porous carbon that is mainly amorphous in phase. The carbon is necessary for this process in the formation of CO and CO₂. During the microwave process, the oxides that were formed during the roasting of the raw e-waste are converted (reduced) back to either their metallic forms or to a carbide. What has been observed is carbide formation is a potentially high-purity phase for some of the targeted elements.

The carbon is important to microwave conversion because it not only facilitates the reduction process but also is a microwave sink. A microwave sink is a material that readily absorbs microwave energy. In the absence of carbon, it is often difficult for the microwave to couple with the raw e-waste. The good coupling nature of carbon has to do with the dielectric properties of the carbon. The semiconductor nature of carbon and the high loss characteristics are responsible for the carbon's electromagnetic response. An interesting observation is that coupling with the carbon is actually a function of the temperature. This is reasoned to be due to the change in the carrier density and subsequent dielectric properties as the temperature increases. Further investigation is necessary to explain this response fully, but this observation was made in the disclosed system. This microwave system provides precise control of the microwave energy and allows a more scientific understanding of the process.

However, actual Ta capacitors were pyrolyzed early on in the process and this can be done with a simple furnace or within the microwave reactor. The difficulty in this process is handling of the off-gassing of different hazardous products. This requires development beyond the scope of this project. Some quick characterization of the e-waste was conducted to identify the composition. An XPS-type analysis should be sufficient to identify most compositions. However, it should be noted that XPS has some limitations for heavier elements such as Ta. In this case, a multi-XPS setup will be necessary to analyze these heavier elements. Then a secondary XPS will be used for lighter elements. This matter has been discussed with the XPS manufacturer and they have confident this is a viable solution. Based on this compositional information from XPS analysis, it is necessary to tailor the subcycles of the process. This means the temperature, pressure, and duration of each subcycle. The goal is to either form a fully reduced metal or a carbide that meets or exceeds the program objectives. The number of subcycles could be as numerous as the number of elements that yare desired to extract. Moreover, in the case of evaporated phases that condense within the condensing section, it is possible to take these oxides and put these back into the microwave system by themselves with carbon and convert them to more stable oxides by processing them in an oxidizing atmosphere. This oxidation process will actually happen in most cases in the atmosphere but using the microwave will speed up the process and provide phase separation.

Additional techniques can be used to further increase the purity of the samples. This could be a post-leaching or electrowinning process. These processes, while they have challenges with mixed streams, they have been proven for achieving high purity of select single-stream processing. Most of these processes are well understood and can be developed quite readily.

### Analysis of E-Waste Feedstock

An initial analysis of pyrolyzed e-waste material was conducted. A pilot scale digester pyrolyzes the e-waste and manages all the toxic and hazardous by-products of converting e-waste to carbon and metal fines. The largest elemental component of the e-waste is carbon, as expected by visual inspection of the inset photo of the pyrolyzed e-waste. The char, charcoal, or carbon is coming from the pyrolysis of the organics (paint, polymers, coatings) and is a black material. The second largest elemental component is copper, the targeted element for this study. Copper is mainly coming from the electrical traces on PCBs but also from electrical connectors and microelectronic (CPUs, MOSFETs, rectifiers) substrates. Copper makes up nearly 20% of the material in the pyrolyzed e-waste. A quantitative phase analysis (QPA) of the phase composition can be conducted using XRD data. This provides a quantitative metric of the crystalline material within the sample. All the phases were oxides, with the exception of metallic zinc. This is an important finding as the material analyzed has undergone a roasting process. Essentially, during the pyrolysis process, all of the metal fines within the digester are converted to an oxide phase. This is known as the roasting step in the mineral as is a critical phase of the recovery process. In the absence of this roasting step during pyrolysis, it would be necessary to do this within the microwave. The crystalline phases of copper found in e-waste are copper oxide tenorite (CuO) and cuprite (Cu₂O) with tenorite having the larger component. Cuprite is a more thermodynamically stable oxide, so by having a tenorite phase the processing energy is actually decreased.

Meanwhile, copper is the largest component in pyrolyzed e-waste. It was found that lead is a large component of e-waste, making up approximately 0.6% of the e-waste material. That equates to 6 g/kg of e-waste, a surprisingly high level. This is nearly six times the Restriction of Hazardous Substances (RoHS) limit set at 0.1% in California. The issue is not necessarily that the concentration is high, even though this has a health concern, it is that it makes it difficult to recycle copper when lead is present or in high concentrations. Moreover, the targeted application for copper used in transmission lines requires high purity, which means that lead and other alloying elements need to be separated. It is suspected that the lead is coming from 1) old components that used lead-based solder and did comply with RoHS standards, 2) leaded brass and copper connectors, and 3) lead used in industrial surface coatings and inks. Further investigation reveals the presence of Sn, Ag, and Zn, which is the modern substitute for Sn—Pb solder. It is believed there will always be a mixture of unknown e-waste with varying concentrations of Pb. The disclosed technology has the ability to handle the presence of lead.

Further investigation shows there is not a lone phase of lead or lead oxide. However, a tin oxide phase of cassiterite (SnO₂) is observed, which is encouraging as the tin will phase separate during the roasting process. It is suspected because lead does not phase separate, that the lead forms a binary alloy with copper. This, in fact, leads to the complication of separating lead from copper. The separation of the lead from copper oxide is accomplished using a selective microwave refining approach.

The selective refining approach described herein takes advantage of several attributes of the microwave. First, the microwave energy couples with the residual carbon or char that is left from the pyrolysis process. This means that the carbon does not need to be removed from the pyrolysis by-product but can be used directly. The second attribute of the microwave is that as soon as the reduction has been completed and the carbon has been utilized in the vicinity of the oxide, the reaction stops. This results in a localized heating effect that avoids the necessity of heating the whole material and surrounding insulating materials, which would be required in a traditional furnace. The third advantage is that a CO plasma can be initiated and sustained by the microwave, which aids in the local thermodynamics of the reduction process, physical separation, and non-equilibrium cleaning action. It has been found in previous studies that if the correct thermodynamic phases and states are considered, specifically the ionized states of the plasma, the thermodynamics of the process can be predicted with great accuracy.

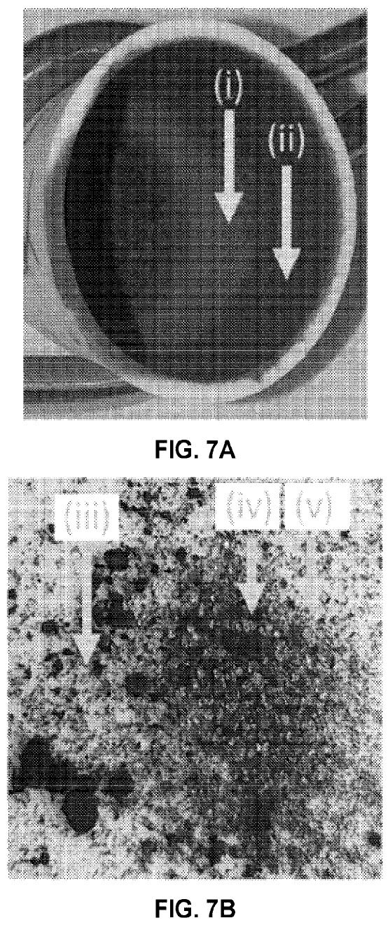

The separated phases are either collected as condensed phases within a custom microwave collector, which termed herein as an “applicator.” An illustration of the proposed applicator design can be seen in FIG. 10. The evaporated phases such as lead are collected downstream, whereas a solid phase that resembles a spherical metal sponge material is collected below the sample. The condensed phases that are collected above the reaction in the custom applicator are in the form of a condensed metal phase or a secondary phase such as carbides, nitride, chloride, or oxide. The formation of the secondary phases is possible by injecting a cold gas such as nitrogen into the plasma stream, condensing out a solid material. This solid material is collected at a different level of the downstream applicator and removed with a continuous vacuum. The solid phases that are collected at the bottom of the reaction are in the form of small metal sponge (porous metal) spheres. Both the evaporated phases and the metal sponge phases appear at precise reaction temperatures and gas partial pressures. The gas partial pressures and specifically the oxygen partial pressures are an important aspect of this approach and are often overlooked in microwave catalysis studies. In the absence of oxygen partial pressure control, reduced metal phases with oxides and carbon will not fully reduce. Data shown in FIGS. 7A-7B is a result of a quick scoping run that was conducted using a mixture of copper oxide and lead oxide. The mixture of carbon with oxide materials was placed within an alumina crucible, as seen in FIG. 7A. The microwave was run with prescribed temperature control to selectively condense lead seen on the edge of the crucible (i) in FIG. 7A. The microwave was run to a max temperature of 1450 °C. At this temperature, both lead and copper with reduce and the lead will evaporate. As seen in FIG. 7B, solid phases of copper (iii-v) are present as metal sponge material that remained in the crucible. There is carbon remaining that is presented as a black powder in FIG. 7B. The optimization of the process will require a flux to be identified that will prevent the reaction from attacking the crucible as seen in FIG. 7A and to help with phase separation of metal sponge material. But this is an encouraging first run that demonstrates that this process will work.

Further processing of the phase-separated condensed phases and metal sponge was conducted to increase the purity of samples. The powders were physically collected and a subsequent oxidation step was used to convert the secondary phases to their metallic phase. An example of this might be the collection of Mn₃C powder and the secondary vacuum refinement resulting in metallic Mn and O₂. The metal sponge material that is collected at the bottom of the application, which resembles small BBs as seen in FIG. 7B, was electrostatically separated and melted into an ingot using the electron arc melting technique. The separation of the larger material was done using an electrostatic separation technique.

### Example 4: Optimization of Experimental Conditions

Recovery of Ta Metal from Capacitors

Initial experiments were conducted on Ta capacitors to understand microwave irradiation of e-waste in a multi-mode microwave system. Ta capacitors were pyrolyzed in air at 800 °C and 0 to 50% (w/w) carbon black was added. These were mixed for 1 h using a dry roll mill; in a typical experiment, 0.1, 0.5, or 2 g of carbon black, pressed or loose, was used with 1 or 2 g of Ta capacitor powder. Powder mixture was weighed out, compacted loosely in an alumina crucible, and placed inside an insulation package in a microwave cavity. Constant powder microwave pretreatment was carried out (2 KW, 2.45 GHZ, 2-20 min, under Ar flow).

Less than 0.5 g of carbon resulted in low coupling and heating rates, where insulation and waveguides showed preferential heating, but no heating after 20 min. Weights of 0.5-1.0 g heated after 15.5 minutes to 871 °C and kept rising, then isolated between 900 and 1100 °C. Weights of about 1.0 g carbon heated in 4 min to 871 °C and increased to 1570 °C in 20 min; however, this rapid pace caused the insulation package to crack.

In some experiments, 2 g Ta capacitor powder was irradiated at 2 KW in Ar. After 20 minutes, no temperature change was detected. Inspection by IR temperature measurement after opening the cavity showed the sample heated to only about 200 °C (i.e. no intrinsic microwave coupling was observed), with samples displaying no major weight loss.

When a 2 g mixture of Ta capacitor powder and carbon powder (1:1 weight ratio) was irradiated at 2 KW in argon gas, heating occurred within 50 s; temperature accelerated to 1200 °C and continued to 1400 °C in 1 min. The run was then stopped. This rapid heating cracked the insulation lid and split the crucible. Melted metal balls were identified in the remaining powder. A rate of about 27 °C/s of heating for a 2 g sample has been achieved, with the magnetron delivering about 2 KW of power. About 200 W of heating at the sample is being delivered. If a vacuum is pulled, a 2.5% increase in ramp rate can be achieved. A 6 KW magnetron results in about a 3× increase in ramp rate to 81 °C/s. Increasing microwave power can achieve higher heating rates but the 3000 °C/s to sublimate materials may not be achievable in a multimode system.

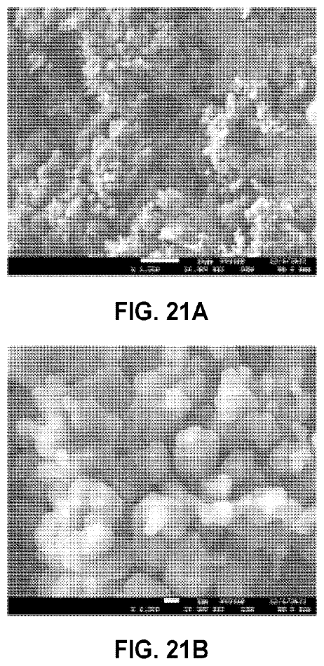

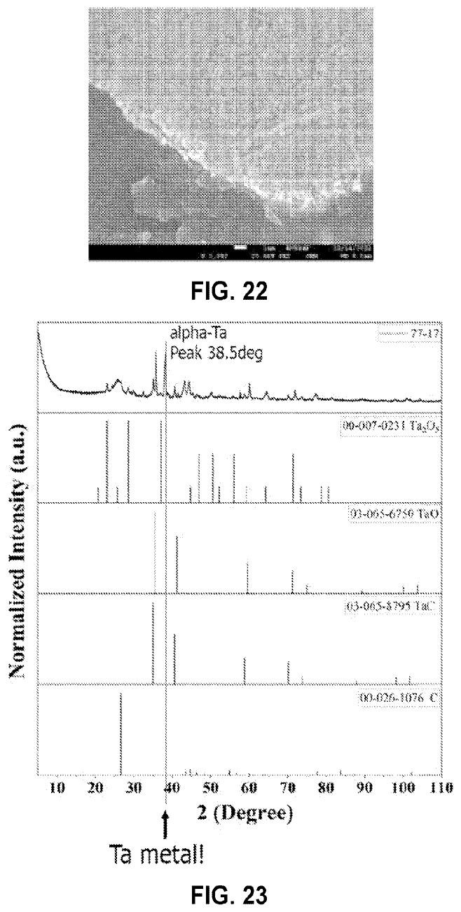

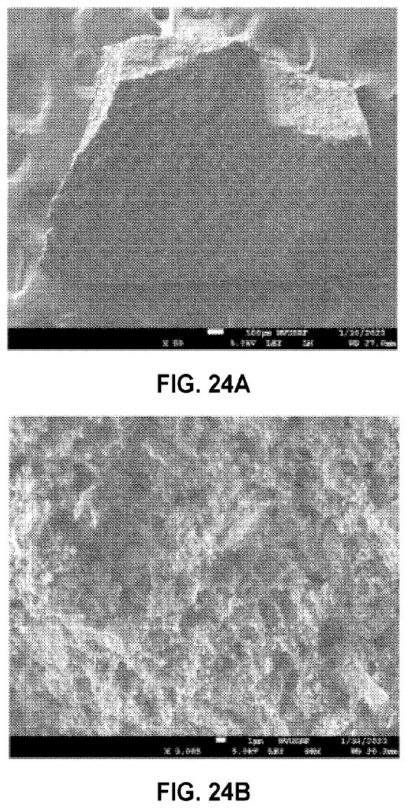

SEM and XRD analysis was conducted of Ta agglomerates from these runs. Agglomerate size and composition changes based on microwave power, with lower power resulting in ductile, larger agglomerates. Higher power resulted in brittle, smaller agglomerates. Alpha-Ta and TaC were the largest percentages according to XRD. SEM images of the agglomerates are shown in FIGS. 21A-21B. The agglomerates were mounted in epoxy and polished to expose a cross section (FIG. 22).

XRD shows the agglomerates are composites of alpha-Ta, TaC, TaO, and Ta₂O₅ phases. XRD analysis is shown in FIG. 23.

### Indium Tin Oxide Experiments

For some experiments, indium tin oxide (ITO) powder was used. 1.25 g of ITO powder was irradiated at 2 KW in Ar gas. Heating occurred within 32 s, wherein the temperature accelerated to about 1385 °C, with continued fluctuation between 1370 and 1385 °C. In 4 min, the experiment was stopped for safety reasons. The sample was not ejected from the setup, but a small corner of the crucible had melted. Sample examination provided dirty yellow powder mixed with different colored pieces, indicative of believed contamination.

In a second run, 1.5 g of an ITO/carbon powder mixture (70:30 wt ratio) was irradiated at 1 KW in Ar. The crucible was placed on a pedestal to reduce heat transfer. Heating occurred within 1 min with the temperature rising to 871 °C and abruptly dropping. Temperature rose steadily to 880 °C before dropping again. The run was terminated as temperature dropped, indicating a violent reaction. The sample had been ejected from the crucible but the crucible was intact.

XRD analysis showed indium metal being reduced out of the oxide.

Recovery of Ta and Mn Carbide from Capacitors Experiment

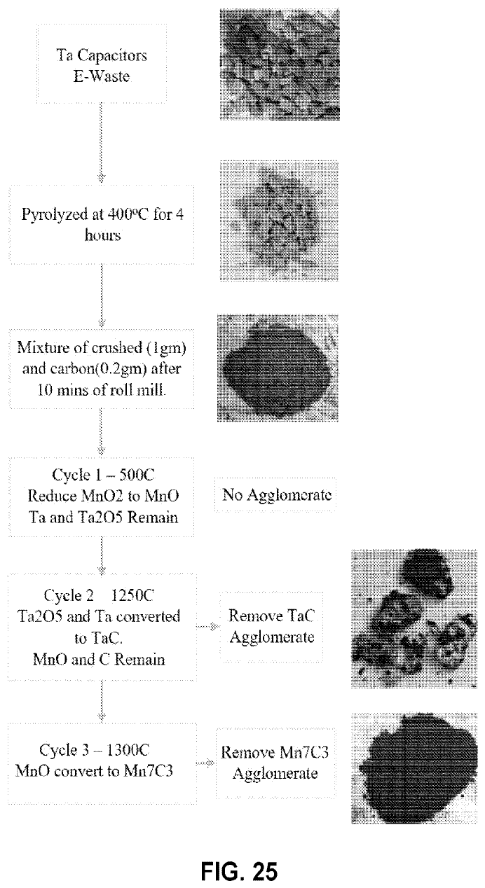

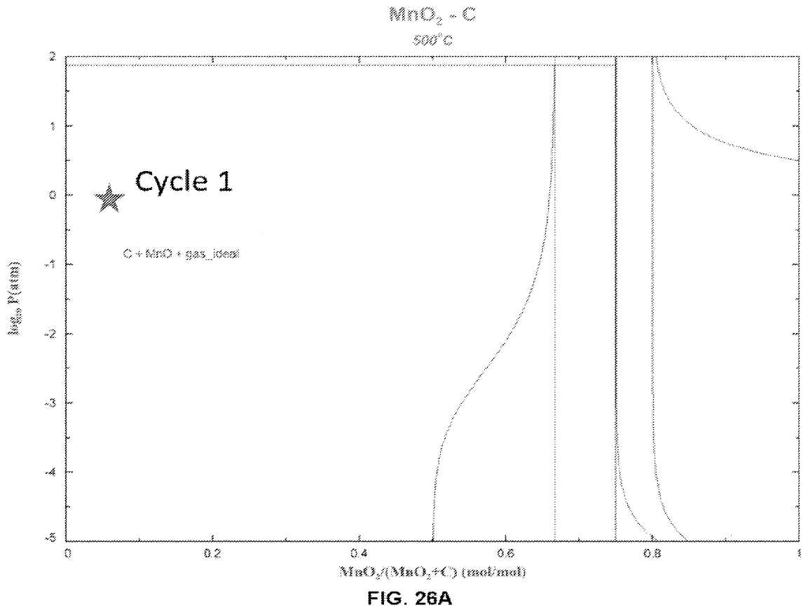

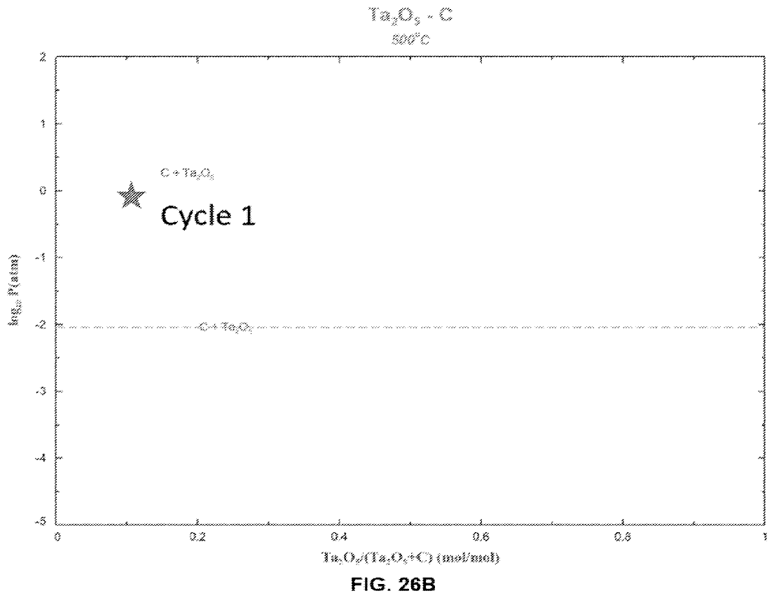

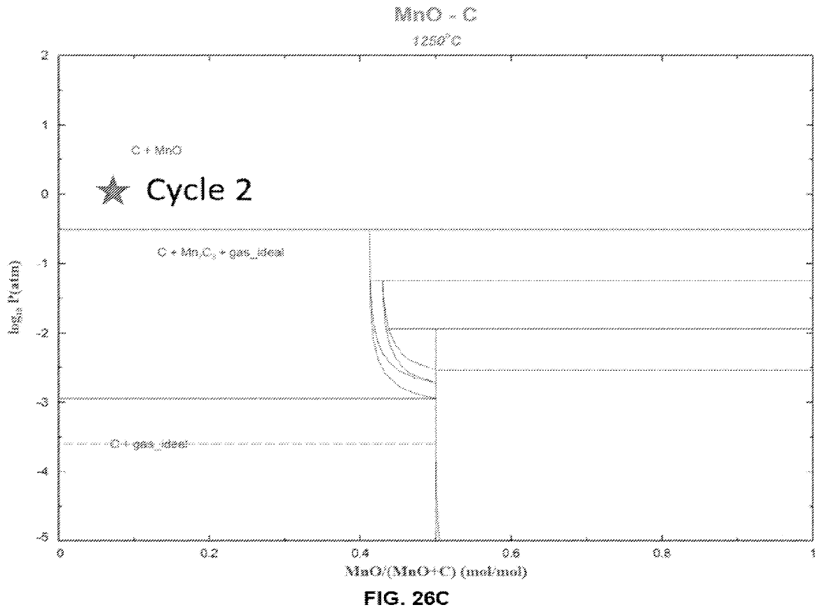

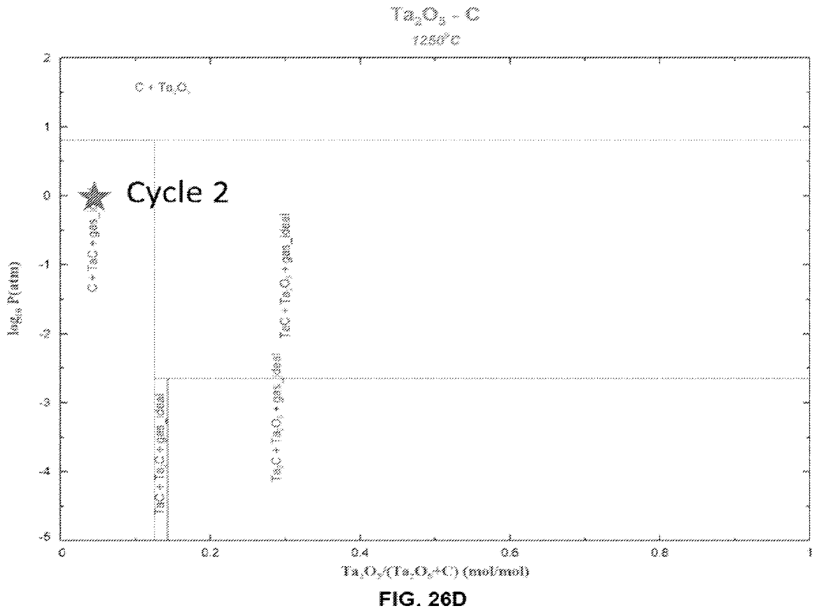

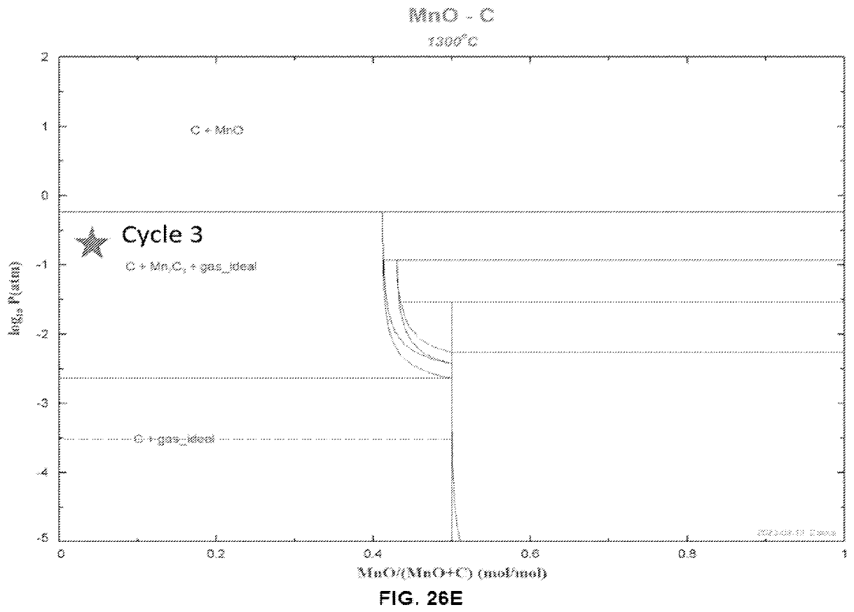

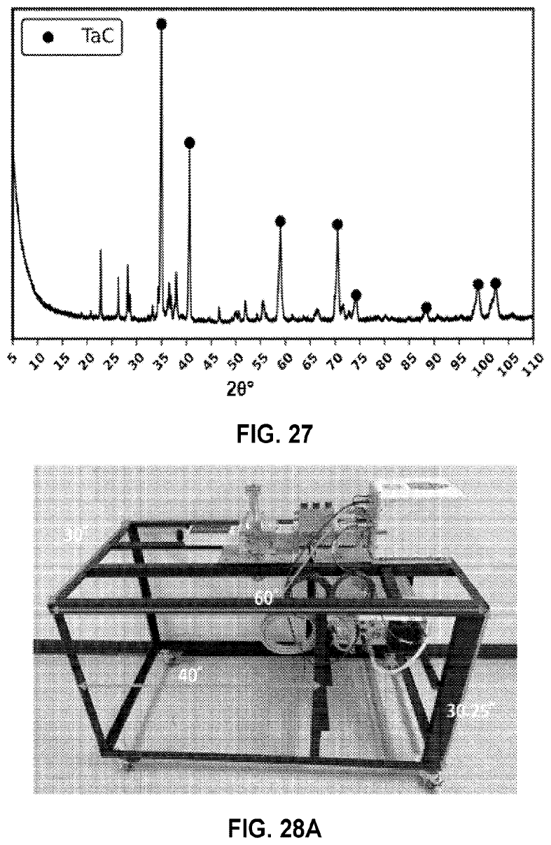

As-received Ta-capacitors as seen in FIG. 25 were pyrolyzed in a furnace at 400 °C for 4 hours was conducted to remove paints, organics, and low melting point metals. Ta capacitors were crushed using a ball mill. 1 gram of crushed Ta capacitor material was combined with 0.2 grams of carbon black, as seen in FIG. 25. The first cycle involved heating within microwave to 500 °C to convert MnO₂ to MnO. The second cycle involved heating to 1250 °C to convert Ta₂O₅ and Ta to TaC. The TaC agglomerate that was formed was physically separated from the mixture. An image of the TaC agglomerate is shown in FIG. 25. The associated XRD for the TaC agglomerate is provided in FIG. 27. The remaining mixture was heated within the microwave and MnO was convert to Mn—C₃ for cycle 3. The resulting Mn—C₃ can be seen as a white oxide within the remaining carbon mixture in FIG. 25. were crushed. Purity and recovery of Ta in the TaC agglomerate phase as measured by ICP-MS are shown in Table 4:

TABLE 4
Recovery of Ta in TaC Agglomerate Phase

| Element | Purity (%) | Mass Recovery (kg/hr/ton) |
|---|---|---|
| Ta | 96.532 | 3394.96 |
| Mn | 2.160 | 75.97 |
| Ni | 1.308 | 46.001 |

### Microwave Encapsulation for Multimode System

A large Pyrex desiccator was used for some experiments. A vacuum was created inside the desiccator of about 27 in Hg using a vacuum pump. This was placed in the microwave cavity with no internal or external insulation. In future experiments, reactants and products need to be contained to eliminate violent gas expansion.

A Ta capacitor surrogate model was begun with two major components of the anode. In one experiment, 1 g Ta₂O₅, 0.5 g MnO₂, and 0.3 g of carbon black were used after ball milling together. The mixture was placed inside the insulation package inside the microwave chamber and a vacuum pulled of −24 in Hg. No Ar gas was pumped and power was set by program to ramp to 871 °C, then increase to 1400 °C at 30 °C/min and hold for 15 min before termination. Heating occurred within 18 s and temperature stayed constant for 11 min before increasing to 1331 °C and crashing back to 871 °C. Sample had not been ejected for crucible and no damage to the setup was observed. Sample stained sides of the crucible and turned to a maroon powder.

From 1 g of Ta₂O₅, about 0.818 g Ta should be present. From these experiments, a sample agglomerate had a mass of 0.166 and represents about 25% recovery of Ta metal, with some Ta₂O₅ remaining that has not yet been converted. Agglomerates exhibited some magnetism.

### Mn and Ta Reaction

MnO₂ is a less stable oxide than Ta₂O₅, with a melting point of about 550 °C and a boiling point of about 900 °C. Ta₂O₄ melts at about 1150 °C with a Ta reduction temperature of >1400 °C. Two potential separation approaches include evaporation of Mn and phase separation of Ta plus Mn slag.

A powder of MnO₂ and carbon was run as a baseline experiment. 0.509 g of MnO₂ and 0.301 g of carbon are milled in a roll mill for 10 min and the mixture was placed inside an insulation package inside the microwave chamber. A vacuum of −24 inHg was pulled on the chamber. Heating occurred within 8 s and rose to 1221 °C, constantly fluctuating due to program reducing power to match a desired step function. The reaction ended at 5 min by program termination. Sample inspection provided no beads or agglomerates. Only brown powder with black powder indicating completely reacted MnO₂ and C to form Mn carbide. Quantitative powder analysis revealed 17% Mn₃C, 14% MnO, 14% Mn—C, and 10% delta-Mn.

A powder of Ta₂O₅ and carbon was run as a baseline experiment. 1.004 g of Ta₂O₅ and 0.308 g of carbon are milled in a roll mill for 10 min and the mixture was placed inside an insulation package inside the microwave chamber. A vacuum of −24 inHg was pulled on the chamber. Heating occurred within 10 s and rose to 1352 °C, constantly fluctuating due to program reducing power to match a desired step function. The reaction ended at 5 min by program termination. Sample inspection showed a large lump of blue-brown metal alongside many small silver-colored beads.

A powder of Ta₂O₅, MnO₂, and carbon was run as a Ta-capacitor substitute experiment. 1.029 g of Ta₂O₅, 0.501 g of MnO₂, and 0.309 g of carbon are milled in a roll mill for 10 min and the mixture was placed inside an insulation package inside the microwave chamber. A vacuum of −24 inHg was pulled on the chamber. Heating occurred within 8 s and rose to 1400 °C, constantly fluctuating due to program reducing power to match a desired step function, staying in the range for 2 min. The reaction ended at 5 min by program termination. Sample inspection showed a large lump of metal on the bottom and a brown substance staining crucible walls. The crucible fractured. A repeat run was conducted with 1.002 g of Ta₂O₅, 0.508 g of MnO₂, and 0.305 g carbon. Heating occurred within 16 s and rose to 1398 °C. After 16 minutes step program terminated the reaction. Black powder was present with several silver beads of various sizing. Results were reproducible. Total mass was 0.848 g, higher than the expected 0.818 g. ICP-MS determined 74% of the mass was Ta.

A powder of Ta₂O₅ (1.001 g), MnO₂ (0.502 g), carbon (0.303 g) and Ag (0.0993 g) was used as a Ta capacitor simulation. The sample was milled in a roll mill for 10 min and the mixture was placed inside an insulation package inside the microwave chamber. A vacuum of −24 inHg was pulled on the chamber. Heating occurred within 8 s and rose to 1260 °C, constantly fluctuating due to program reducing power to match a desired step function. The reaction ended at 10 min by program termination. A brown substance coated the walls of crucible and lid. Bottom of the crucible had beads stuck to it.

A powder of Ta₂O₅ (0.249 g), MnO₂ (0.501 g), carbon (0.302 g) and Ta (0.751 g) was used as a Ta capacitor simulation. The sample was milled in a roll mill for 10 min and the mixture was placed inside an insulation package inside the microwave chamber. A vacuum of −24 inHg was pulled on the chamber. Heating occurred within 4 s and rose to 1400 °C, constantly fluctuating due to program reducing power to match a desired step function. Highest reaction temperature was 1455 °C. The reaction ended at 6 min by program termination. During the run, green flames were observed at times of temperature peak and inspection showed most material reacted with only a few agglomerates present.

### Post-Run Analyses

XRF was able to provide an estimate of Mn remaining in the carbon, most likely in the form of Mn carbide. Silica in the crucible is likely reacting with carbon, causing crucible failure. Crucibles used were 99.7% alumina with traces of MgO and SiO₂.

1 g of Ta₂O₅ contains 0.818 g total of Ta metal. Post run, the total mass of agglomerates was 0.848 g. ICP-MS of agglomerates returned 74% Ta and 26% Mn, with a purity of 74%. This equates to about 0.67 g of Ta, or a recovery of 77%.

### Fractional Recovery Approach

A surrogate Ta-capacitor material was constructed from 1.008 g Ta₂O₅, 0.504 g MnO₂, 0.456 g carbon, 0.506 g Ga₂O₃, and 0.504 g In₂O₃. The sample was milled in a roll mill for 10 min and placed inside an insulation package in the microwave chamber, in which a vacuum was pulled of −20 inHg. Ar gas was flowed in at 60 ft³/h until −10 inHg, then vacuum reestablished at −20 inHg. Ar flowed through the experiment at 30 ft³/h. Heating occurred within 12 s and followed a program of a 900 °C hold for 5 min, a 1020 °C hold for 5 min, a 1250 °C hold for 3 min, and a 1450 °C hold for 5 min. The crucible was stained brown, white, gray, and yellow, with small beads and a shiny silver-colored deposit at the bottom.

It is believed that MnO₂ partially reduces to Mn₃O₄ and then to MnO. MnO₂ is a liquid above 570 °C, while MnO is solid until 1250 °C but will begin to be reduced by CO at 1200 °C. Mn metal has a melting temperature of 1200 °C and a boiling temperature of 2000 °C. A step added to reduce MnO to Mn or Mn—C₃ could facilitate the process, allowing for vaporization of Mn₃C. It is believed that pO₂ and cooling rate govern carbide formation.

Ta₂O₅ melts at about 1872 °C. Reduction of Ta₂O₅ happens around 1450 °C. If pO₂ is greater than 10-3 atm, TaC will form. If less than 10-3, Ta metal will form. It is believed that Ta₂O₅ can be reduced to TaO gas phase. If Ta is not removed as TaC or Mn is not removed by evaporating as Mn₃C, a stable Ta₂MnO₅ phase is formed (tantalite).

1.012 g of Ta₂O₅, 0.507 g of MnO₂, and 0.306 g of carbon were milled in a roll mill for 10 min, placed in an insulation package inside the microwave, and a vacuum of −18 inHg pulled. N₂ gas flowed at 60 ft³/h to −10 inHg and then vacuum was reestablished at −20 inHg. Heating occurred within 8 s and followed the fractional recovery program outlined above. After the 900 °C hold with N₂ flowing at 30 ft³/h, the sample included brown powder mixed with unreacted carbon and Ta₂O₅.

Stable spherical phases were formed in an N₂ atmosphere, with less staining of the crucible.

### Ga and In Refining Process

Ga₂O₃ and In₂O₃ when reduced will collect on the bottom of the crucible as shiny material. If reheated in 1 atm pO₂ atmosphere, both In and Ga can be converted back to oxides and collected. Ga is observed to embrittle alumina crucibles.

Test Runs with E-Waste

1.295 g of e-waste (as received) and 0.15 g of carbon were run for 10 min at atmospheric conditions with 0.49 g of small balls extracted. In another experiment, 1.295 g of e-waste and 0.15 g of carbon were run for 10 min in vacuum with 0.539 g of small balls extracted.

### Example 5: Process Refinement

### Processing Steps and Results

A series of controlled runs was conducted in an existing multimode microwave system. The run was stopped after each processing step and physically separated the material. Some of these material were separated as agglomerates and some of the material were separated as a condensed phase on the wall of the crucible. Associating this with the prototype design shown in FIG. 10, the agglomerates of sponge material will be collected at the bottom and the condensed phases that were found on the side of the crucibles will be collected on the top portion.

The first processing step was to take the mixed oxide material with carbon and place this in the microwave system at a temperature of 900 °C. Above 700 °C the formation of CO becomes greater than CO₂. CO is desirable as the reducing agent because it provides the advantage of reducing at lower temperatures. This can be seen in FIG. 14 where the downward-sloping line is 2C+O₂=2CO and the horizontal line is C+O₂=CO₂. Again, the more negative the Gibbs energy the more stable the oxide. Therefore, CO₂ is more stable at room temperature compared to CO. At 900 °C it is seen that MnO₂ will partially reduce and coalesce as an agglomerate combined with Ta₂O₅ powder. MnO₂ will be reduced to a lower oxide, MnO, and remain mostly around carbon. The brown powder is the MnO and the well agglomerate is 84.1% Ta and 14.1% Mn. The agglomerate is removed at this point and run through ICP-MS and XRD. The mass of the agglomerate is 0.48 μm, which is a large percentage of Ta. The remaining powder is processed further at the next temperature.

Next, the remaining powder minus the agglomerate is placed back into the crucible and ran at 1020 °C for 7 min. The wall condensed phase is 39% Ga and 44% In. This means the majority of the In and Ga is evaporated at this temperature. The collected agglomerates phase is mainly Ta some Mn with a mass of 0.5 g. This is a recovery of 34% of the Ta. Nearly 78% of the Ta is collected at this point. The major finding at this step is that In and Ga leave by evaporation and condensation on the crucible walls.

Next, the temperature is ramped to 1250 °C. At this temperature, Ga₂O₃ is reduced by the CO forming a white powdery material. ICP-MS analysis confirms that the remaining In and Ga are recovered at this step. A small fraction of Ta powder is taken out and there is some Ta₂O₅ remaining with the carbon. Ta₂O₅ powder and carbon remain at the bottom.

The final processing step is to convert the remaining Ta₂O₅ at 1450 °C but there seems to be some Mn remaining. The mixture reacts with the crucible forming a tantalite phase that is stuck to the bottom of the crucible. The amount of Ta lost to this final reaction is approximately 20% or less. It is believed this can be removed by adjusting the first and second-cycle reaction times.

In addition to running the argon case shown in FIG. 13, nitrogen-purged gas was also explored. The process flow chart is shown in FIG. 15. A difference in processing products that await ICP-MS and XRD analysis is observed. One thing noticed in cycle three is the formation of Mn or Ta metal sponge spheres. It is hypothesized that a combination of gases might actually provide the optimal method of extraction.

TABLE 3
Phases Extracted at Processing Temperatures in FIG. 13

| | | |
|---|---|---|
| Element | Mass Recovered (mg) | Percentage Recovered |

Cycle 1, Agglomerate (A″)

| | | |
|---|---|---|
| Ta | 295 | 44 |
| Mn | 50 | 43 |
| Ga | | 0.9 |
| In | | 0.8 |

Cycle 2, Wall (B′)

| | | |
|---|---|---|
| Ta | 12 | 1.7 |
| Mn | 9.8 | 6 |
| Ga | 47 | 30 |
| In | 53 | 26 |

Cycle 2, Sponge (B″)

| | | |
|---|---|---|
| Ta | 229 | 229 |
| Mn | 56.6 | 56.6 |
| Ga | 41 | 41 |
| In | 48 | 48 |

Cycle 3, Wall (C′)

| | | |
|---|---|---|
| Ta | 140 | 21 |
| Mn | 37 | 24 |
| Ga | 66 | 42 |
| In | 100 | 49 |

### Refinement of Process Parameters

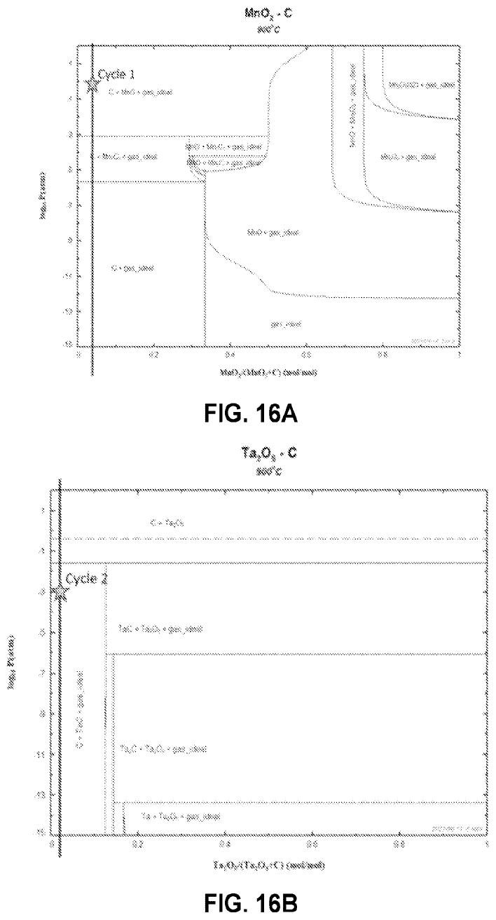

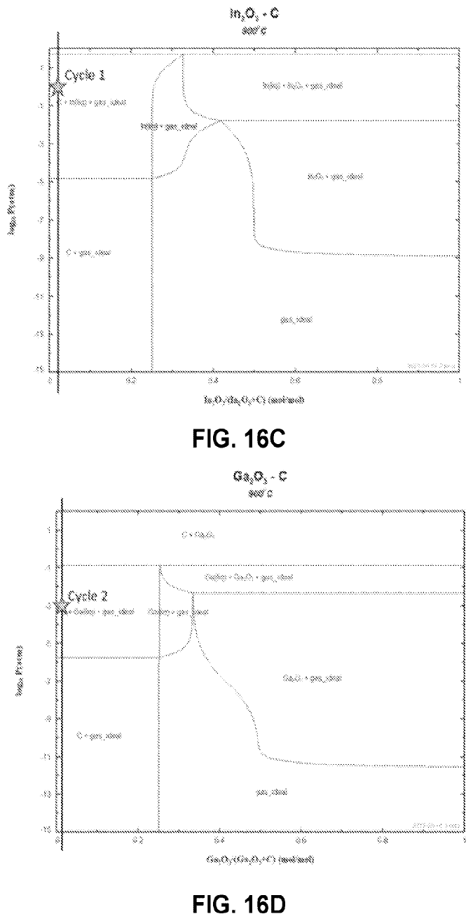

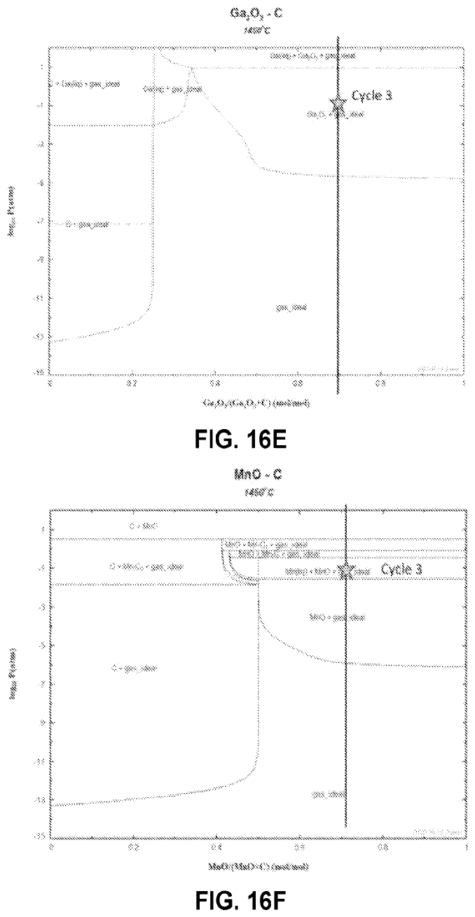

The process parameters are critical to selectively refining from a mixed stream of e-waste using the proposed microwave process. The pressure, temperature, and duration have been found to be critical in controlling the process. For this project, as discussed in previously, the Ellingham Diagram (ED) provides a starting point for identifying the processing parameters. The ED provides the stability of different oxides in comparison to competing reduction processes. To further refine this process, this is important for phases that have lower vapor pressures. This is specifically of interest for the separation of Ga and In. To aid in controlling the pressure, a CALPHAD (Computer Coupling of Phase Diagrams and Thermochemistry) method has been used to refine the process. FIGS. 16A-16F a summary of the derived phase diagrams for the refined process. The process has three cycles that have controlled temperatures and pressures. The first cycle is at 1 atm of pressure under Ar atmosphere at 900 °C. At this cycle, MnO₂ is converted to MnO and In₂O₃ is converted to In. The remaining powder is a brown powder, identified as MnO. At the bottom of the crucible is a shiny metallic material that is In. More carbon was added to the crucible and just the crucible was rerun, resulting in shiny metallic material at the bottom. In was thus converted back to In₂O₃ with a purity of 54%. The total mass recovered was 33 mg or 0.033 g with the total Ga mass added 0.37 g, equating to approximately 10% of the Ga being recovered at this step.

The second cycle was to take the remaining powder that contained MnO, Ta₂O₅, Ga₂O₃, and traces of In and pull a vacuum to a pressure of −18 inHg under an Ar atmosphere. The sample was then heated to 900 °C and held for 5 min. Based on the CALPHAD analysis presented in FIGS. 16B and 16D the formation should be TaC and Ga. Based on ICP-MS results, TaC forms with a purity of 72%. The TaC is an agglomerate formation found in the bottom of the crucible. The TaC recovered is 515 mg. During this same cycle, a deposition of In and Ga was recovered from the wall of the crucible. The purity of this deposition is 30% In and 60% Ga. The mass recovered of In is 50 mg and Ga is 65 mg. There was 0.41 g In and 0.37 g Ga mass added to the surrogate, this equation to 12% of In and 17% of Ga mass being recovered.

The third cycle involved taking the remaining powder and adding 0.1 g of additional carbon. At this point, there is about 1 g of powder remaining out of the original mass of 2.93 g. This means about ⅓ of the e-waste remains. The temperature was held at 1450 °C and −18 inHg under an argon atmosphere. Based on the phase diagrams of FIGS. 16A-16F this should produce Mn liquid and Ga₂O₃. A white powder that is Ga-rich was formed. The purity of the white powder was 73% Ga with 60 mg of Ga being recovered. This is a 16% mass recovery of Ga. The remaining Mn that was supposed to come out as a liquid metal forms Mn₇C₃.

The focus at this point has been on achieving greater than 50% recovery and 80% purity. This target has been achieved for Ta, Ga, and In, with improvement necessary Mn. A summary of the results is provided in Table 5 below.

TABLE 5
Recovery and Purity Percentages from
a Surrogate E-Waste Material^{a}

| Element | Recovery (%) | | Purity (%) | Recovery Phase |
|---|---|---|---|---|
| Ta | 64 | (44) | 72 (84) | Ta Carbide |
| Ga | 16 | (30) | 73 (34) | Ga Oxide |
| In | 8 | (49) | 54 (29) | In Oxide |

^{a}Values in parentheses are from FIG. 16A.

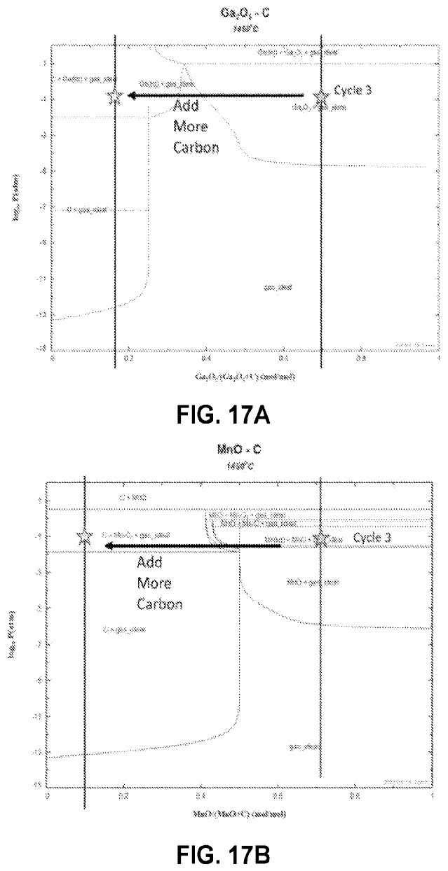

To remedy the ability to recover Mn from MnO and Ga on Cycle 3, a change to the third cycle has been proposed by adding more carbon to the reaction and increasing the pressure. Approximately 0.26 g of additional carbon will be added to the last run for Mn₇C₃ and Ga to collect at the bottom of the crucible. FIGS. 17A-17B show illustrations of this modified design point on the phase diagrams. The temperature will be the same at 1450 °C. Ga will be deposited to the bottom of the crucible and converted to an oxide in a post-cycle run, similar to In on the first cycle. The resulting products are an Mn carbide that can be collected and the Ga oxide.

### Finalized Process

The process developed here involves two major processing steps, where the latter step was the focus of this research. The first major process involves the digestion of the raw e-waste where the feedstock is first crushed, shredded, and ground to a particle size of less than 1 mm. Next, this powder is pyrolyzed to convert the organics to carbon, charcoal, or char. The temperatures are low enough that metallic materials of interest are still solid. Next, the powder is passed through a flotation separation so the bulk of the low-density carbon material can be removed. It is difficult to remove all of the carbon at this step but the carbon can be removed or used in the next major processing step. Next, the powder is put into a rotary kiln where steam is introduced at high temperatures. The steam will aid in the complete oxidation of the metal particles to form metal oxides. While some carbon will be lost majority of the carbon will remain. Next, the stream or water is now driven off by heating the metal oxides and carbon to a moderated temperature below 500 °C. At this point the digester process is complete. The output of this process is metal oxides and carbon. This process effectively roasted the metal components of the e-waste to an oxide. From here the e-waste is now in a stable form and awaits the next major processing step that involves selective microwave refining of select elements.

The next major processing step involves taking the mixed oxide materials from the previous processing step and selectively refining elements to achieve >20 g/hr at 50% mass recovery and 80% purity. The benchtop microwave reactor is a single-mode 3 KW 2.45 GHZ reactor that can control the temperature and pressure of the reaction using a Labview controller.

To selectively refine a mixed oxide that results from the digester processing of a mixed stream of e-waste, the composition of the e-waste is first identified using an X-ray-florescence (XRF) technique. This gives an approximate composition of the incoming stream. Based on the concentration and elemental composition a selective reduction technique based on models developed can be used to determine the number of cycles and the associated temperature pressures. The main approach for the separation of the materials during each cycle is either through agglomerate formation that can be physically separated or deposition of the metal on the walls of the reaction crucible. Both the agglomerates and reaction crucibles will be removed and the next cycle will be processed. Depending on the purity level these materials can be further refined using other well-established refining techniques, such as acid leaching or electrowinning. The major development of this work is determining the thermodynamic processing windows to recover Ta, Ga, and In from a mixed oxide stream.

Based on the overall process, a series of reactions for the overall process is outlined in Equations 1A-3C. The pyrolysis reaction (Eq. 1A) and the oxidation reactions (Eq. 2A and 2B) are associated with the digester process. The carbothermal reduction (Eq. 3A-3C) is associated with the selective refining process using the microwave. During the pyrolysis reaction (Eq. 1) the organics present in the e-waste are converted to carbon. During the oxidation reaction (Eq 2A-2B) the metal present in the e-waste is converted to metal oxides (MOx). The carbothermal reduction involves three cycles to selectively separate elements from the mixed oxides. In this project, a four-oxide mixture of indium, manganese, gallium, and tantalum was used. This oxide selection was selected based on their presence in common DOD e-waste, for example, capacitors, liquid crystal displays, LEDs, and transistors. The number of cycles required will depend on the number of elements that need to be extracted from the e-waste. It was determined through the use of advanced thermodynamic models that the, which will be discussed in the following sections. The first cycle, cycle 1 (Eq. 3A) involves two chemical changes. The first change is that MnO₂ is converted to a lower more stable oxide, MnO. Also, indium is extracted and coats the crucibles in a thin layer. This coating of indium can be heated in the presence of an oxidating atmosphere to form indium oxide. The second cycle takes the remaining oxide mixture, as seen in Eq. 3B, and co-extracts Ga and TaC. Gallium will coat the crucible similar to In and TaC will be a light brown agglomerate. The third cycle utilizes the remaining powder as seen in Eq. 3C and converts MnO to Mn metal, which coats the inside of the crucible.

Pyrolysis:

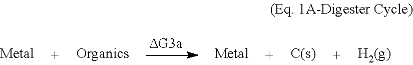

Oxidation:

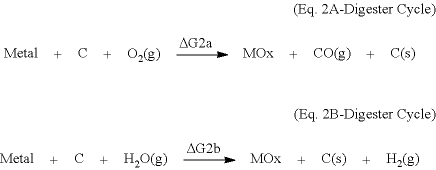

Carbothermal Reduction:

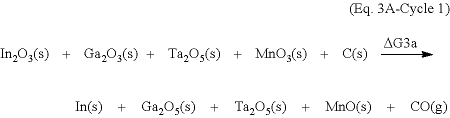

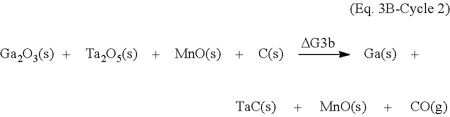

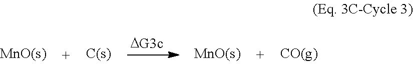

The overall process includes three major cycles as discussed in the previous paragraph. The material is processed in a surrogate mixture of four oxides, 1 g Ta₂O₅, 0.5 g MnO₂, 0.5 g In₂O₃, and 0.5 g Ga₂O₃ with 0.25 g carbon. The mixture is placed within a crucible that is placed with a quartz tube that transverses the waveguide and couples with a compression fitting to the vacuum system. For the first cycle, the temperature is held at 900 °C with an argon atmosphere and a positive pressure of 15 inHg. This temperature and pressure are based on thermodynamic simulations. The first cycle is run for 6 min. An agglomerate forms which is subsequently crushed and reran under the same condition (cycle 1b). The result is the formation of an agglomerate and a shiny metal coating on the surface of the crucibles. This shiny metal coating is indium-rich material. This crucible is removed from the system and indium is converted to indium oxide by reheating the sample in an oxidative atmosphere to form indium oxide. This can be carried out in the microwave but carbon needs to be added and run within the atmosphere to form an oxide. The carbon is necessary to absorb the microwave energy and heat the sample.

The remaining agglomerate and material from cycle 1 are re-crushed and placed back in to a fresh crucible. The temperature is now increased to 1100 °C in an Ar atmosphere at a vacuum pressure of −15 inHg. This results in a large TaC agglomerate that is approximately 89% of the recovered mass at a purity of 84%. This recovery rate taking into account the time to complete cycles 1 and 2 is approximately 2.5 g/hr. This is calculated based on using 1 g Ta₂O₅ feedstock. This yield can be significantly increased by increasing the feedstock mass. More succinctly, if a microwave reactor can be designed to hold a 10 g sample of Ta₂O₅, 25 g/hr can be achieved. The TaC was found to be a more stable product as the production of Ta metal will oxidize in atmospheric conditions. It is believed this is a major breakthrough product of this process, the ability to selectively reduce Ta and form TaC. The purity of the Ta within the TaC sample was measured using ICP-MS to be 84%. During this second cycle, there is the co-extraction of Ga, which is present in the form of Ga metal coating the walls of the crucible, similar to indium in the previous cycle. The crucible is removed after this cycle and the gallium can be converted to gallium oxide by reheating under oxidating environment. At the end of cycle two, there is carbon remaining and MnO.

The material that remains is a mixture of MnO and carbon and undergoes a final reduction of MnO to Mn, as shown in Eq. 3C. The sample is placed within a fresh crucible and the temperature is set at 1450 °C with an Ar atmosphere at a pressure of −27 inHg. This is a slightly higher vacuum than the previous step. Cycle 3 is run for 10 min and the result is the deposition of Mn on the surface of the crucible. The mass recovered from this step was approximately 82% but the purity of samples determined using XRF was low at only 14% Mn. It was determined that some of the Mn was lost to the TaC and there was the presence of In and Ga in the third cycle that reduced the purity of Mn. It is believed that some of the In and Ga were captured within the MnO agglomerates during their formation in Cycle 1.

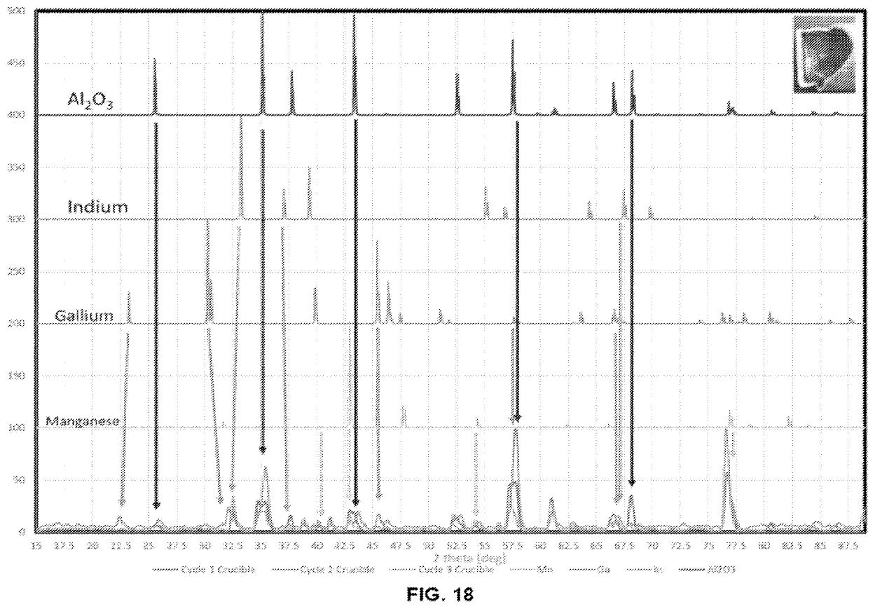

Since all three cycles resulted in metallized coating on the crucibles, an XRD analysis was conducted by crushing the alumina crucibles with the metalized coating and running XRD. The results of this analysis for all three cycles are proved in FIG. 18. These coatings on the wall confirm that the shiny material is a crystalline metal coating of either In, Ga, or Mn. The alumina (Al₂O₃) dominates the spectrum as the alumina was placed within the XRD machine. The results confirm that indium rich crystalline metal is found on the first cycle, followed by Ga-rich material on the second cycle, and finally Mn-rich material on the third cycle. Again, these metalized coatings will be reduced to oxides by heating them back up in an oxidating environment. The oxides can then be readily removed from the crucibles leaving a clean surface.

The overall results for the metrics of the program can be found in Table 5. The extraction element was Ta in the form of TaC, which was an agglomerate. The purity of Ta in TaC was found to be 84% with 89% of the mass of Ta being recovered in the form of TaC. The yield was 2.5 g/hr, which is slightly below the 20 g/hr but was limited by the input sample size. In scaling up this metric of 20 g/hr can be exceeded by simply running 10 g or more of Ta₂O₅ through the process. Gallium was recovered with an 80%, purity at 40% mass, at 0.47 g/hr. Similarly, indium was recovered at 43% purity, 49% mass, and 0.41 g/hr. Finally, Mn, which proved to be one of the more difficult elements was recovered at 82% of its mass at 14% purity, at 0.54 g/hr.

TABLE 5
Recovery and Purity Percentages from
a Surrogate E-Waste Material^{a}

| | Yield | Recovery Mass | Purity | Recovery |
|---|---|---|---|---|
| Element | (kg/hr/ton) | (%) | (%) | Phase |
| Ta | 2500 | 89 | 84 | Ta Carbide |
| Ga | 470 | 40 | 80^{b} | Ga Oxide |
| In | 820 | 49 | 43^{b} | In Oxide |
| Mn | 1080 | 82 | 14^{b} | Mn Carbide |

^{a}Yield calculated based on single runs and extrapolated to 1 hr. TaC was recovered as an agglomerate and all other materials were recovered as metal oxides. TaC purity based on ICP-MS and Ga, In, Mn based on XRF.
^{b}Denotes XRF result.

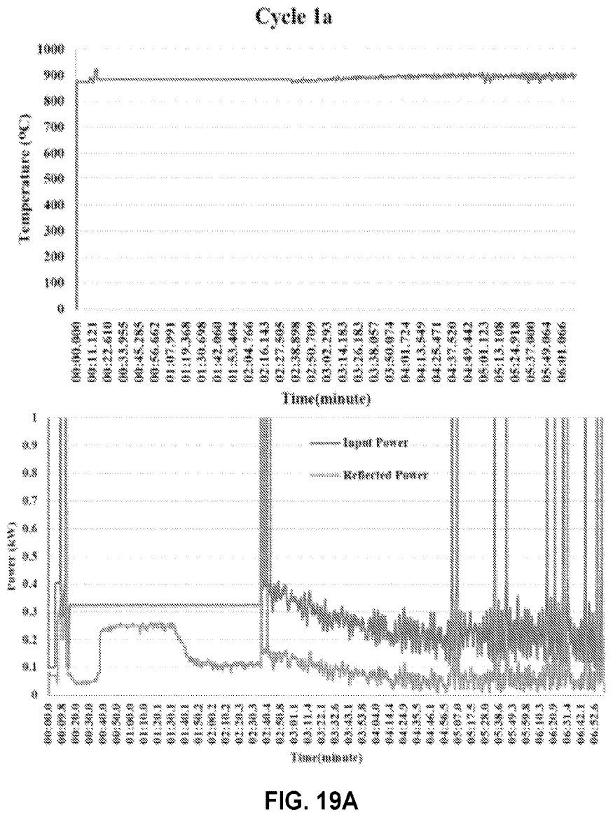

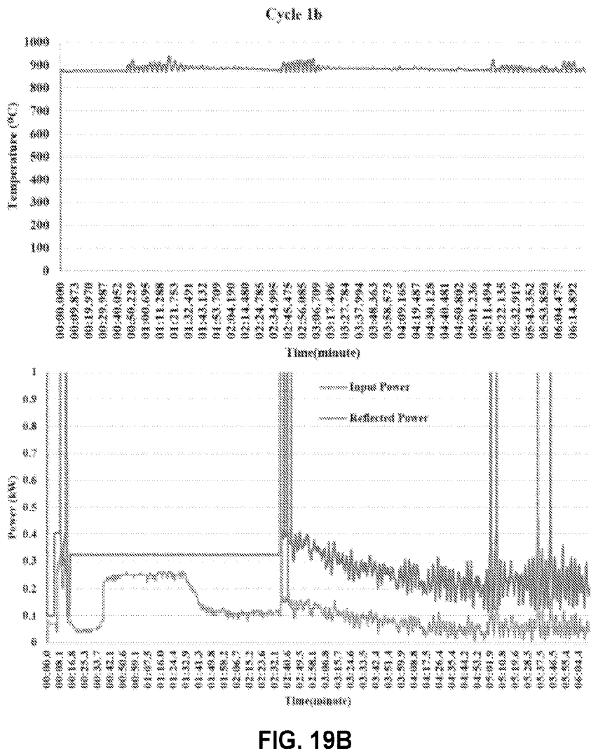

To demonstrate the stability and reproducibility of the process, the temperature time history and the forward and reflected power of the microwave system have been included in FIGS. 19A-19B. This is for cycle 1a and cycle 1b, which are essentially the same parameters. The top plots in FIGS. 19A-19B are the temperature versus time. The run time is around 6 min and the temperature is held at 900 °C. Notice the stability of the temperature. There are a couple of spikes but the PID control system developed in Labview quickly adjusts the microwave. The lower two plots in FIGS. 19A-19B are the forward and reflected power of the microwave system. The max power was limited to 2 KW to avoid large temperature spikes. The first thing to note is that the two runs are very reproducible. The microwave system and control system actually respond in almost an identical time history. This provides confidence and this is a reproducible process that can be controlled in a production environment. The second this that is noted from the forward and reflected powder plots is that the reaction kinetics and be qualitatively evaluated. It is actually noted that around 2 mins that reaction has seem to stop. The input power after 2 minutes is exponentially decreasing, which is representative of the system balancing energy with the temperature loss of the reactor. Prior to this energy is being lost to the chemical reduction process. This gives evidence that the reaction could be terminated near the 2-minute mark. This means the yield was increased threefold or resulted in 7.5 g/hr. There is additional optimization of the process that could be done.

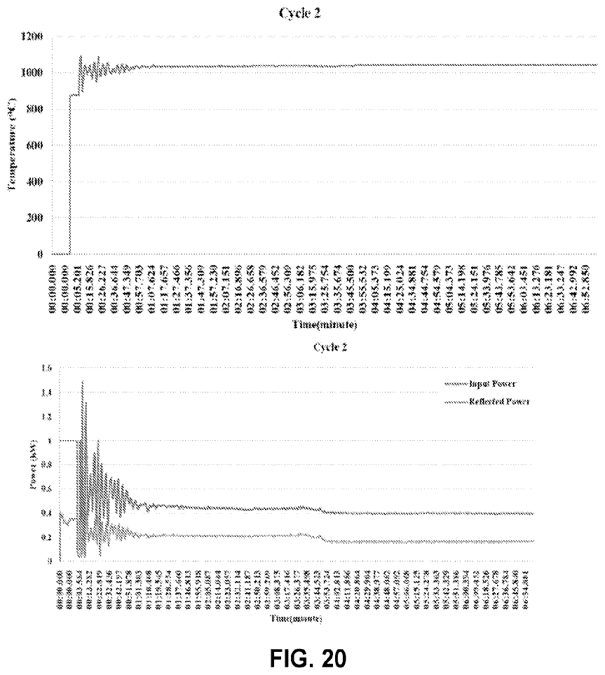

In comparison to a conventional heating approach, it is found that, not only in this research but also in other microwave approaches, that the energy cost savings come in the form of required power. While the energy is governed by thermodynamics the heat transfer or how quickly the sample can be heated within a real enclosure (with thermal losses) is how the power savings are realized. Moreover, the microwave energy in the proposed reaction only strongly couples with the carbon in the system. This results in a self-limiting reaction and localized heating scenario. As seen in FIGS. 19A-19B, the reaction stopped after 2 min while the run continued for 6 min. Complementary thermal runs have been conducted, where the sample is heated using conventional heating and it has been seen that wall time is significantly longer. For example, the formation of TaC from Ta₂O₅/C using a conventional heating approach took over 30 minutes with less yield. It has thus been demonstrated that this can be done in under 7 minutes. FIG. 20 is the cycle 2 temperature time history and forward and reflected microwave power. Again, the dip in the power at the 4-minute mark is an indication that the reaction has completed and TaC is fully formed. This provides an opportunity and justification for further optimization of the microwave process.

It would be advantageous to develop a microwave system that is similar to what was used initially based on retrofitting an available vacuum furnace with a multimode microwave source. Such multimode systems could be built to handle hundreds, if not thousands, of pounds of e-waste at a time.

### Example 6: Copper Refinement

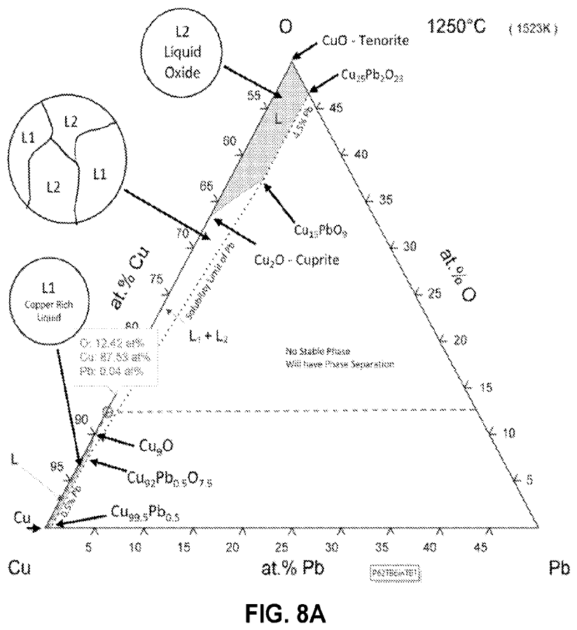

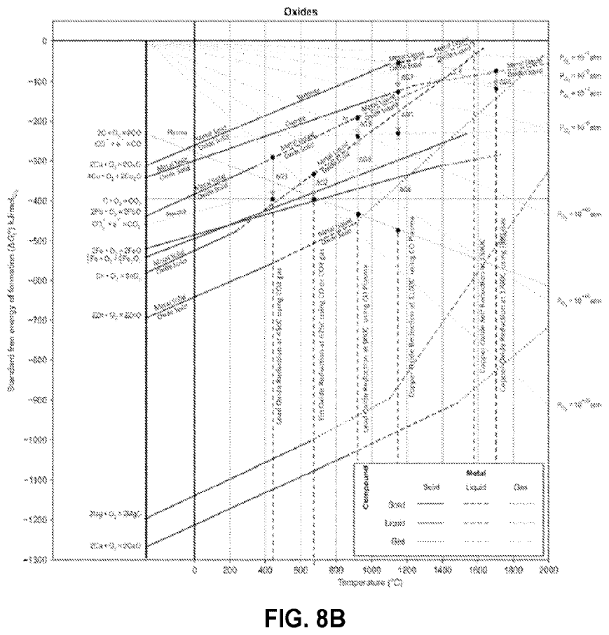

To better understand the thermodynamics of the approach, which are critical to controlling the refining process, the process is illustrated in two figures. FIGS. 8A-8B illustrate the high-temperature phase diagram for the Cu—Pb—O system in FIG. 8A and the Ellingham Diagram in FIG. 8B. The Ellingham Diagram (ED) provides a visual method of visualizing the thermodynamics of the process and specifically the entropy of the process. The y-axis is the Gibbs free energy for the reaction of a metal (M) with one mole of oxygen (O₂) resulting in a metal oxide compound (Mox). The more negative the Gibbs free energy (ΔG=ΔH−TΔS), the more stable the Mox. The x-axis of the ED is the temperature. The system will be operating at a temperature upward of 1200-1400 °C. At these temperatures the enthalpy of the reaction (ΔH) as it is the y-intercept of the ED, the entropy, which is multiplied time the temperature (TΔS) turns out to be more important. This is an interesting concept as the entropy of reaction is sometimes important for room temperature gas phase reactions, in this application the entropy is extremely important. The slope of the lines in the ED, which is the change in entropy (ΔS), is proportional to the slope. Therefore, as there is a phase change in the Mox, say from liquid to gas, or solid to liquid, there is a change of slope. Moreover, the real utility of the ED is to pinpoint inflection points or points where different lines intersect. At these points, there is a change in the stability of the reaction. In the case of this study, carbon is used as the reducing agent. Carbon will react with oxygen and form either carbon monoxide (CO) or carbon dioxide (CO₂). Both of these reactions are on the ED as lines associated with the reaction, C+O₂=CO₂ or 2C+O₂=2CO. If the exact location of the associated intercept of a metal oxide reaction (M+O₂=Mox) is now pinpointed, any temperature beyond this point CO₂ or CO is more stable than the Mox, meaning it can be reduced. This method of tracking the temperature of ED has been demonstrated to work in previous experiments. The precision of the reduction temperature is within 200 °C.

Following along the ED diagram again in FIG. 8B, the holding temperature can be described. It is known that the e-waste contains approximately three times more tenorite (CuO) compared to cuprite (Cu₂O). Focusing on the tenorite reaction in the ED associated with the reaction, 2Cu+O₂=2CuO, the metal oxide is less stable than the cuprite reaction, 4Cu+O₂=2Cu₂O. This is observed in nature as Cu₂O (green oxide) is more prevalent in nature than CuO (red oxide). Even though the stability is different the melting temperature is approximately the same at 1000 °C for the oxides. It has been observed in previous studies that the reaction does not quickly evolve until the oxide phase is in a liquid form. Once in the liquid phase, these reactions are very quick and exothermic. Typically, operation should be at a temperature slightly above the melting point of the associated Mox to overcome any activation energy. In the case of cuprite and tenorite, approximately 1100 °C was selected. At this temperature, both of these Mox compositions can be reduced by carbon monoxide. The CO arises from the reaction of solid carbon with the oxygen in the oxides. Furthermore, above 700 °C carbon monoxide is more stable than CO₂. However, if the differences in Gibbs energy at these points (ΔG5+ΔG6) for cuprite and (ΔG5+ΔG6+ΔG7) are considered, there are extremely large exothermic reactions. This was experienced when the experiment was run in the microwave system pictured in FIGS. 7A-7B. To reduce the reaction energy the excess energy is used to generate a plasma. The microwave energy helps initiate and maintain the plasma as it couples with the free electrons in the plasma. However, it takes energy to ionize the carbon monoxide gas. The ionization process converts one mole of CO and converts it to CO⁻ and an electron (e⁻). The energy to undertake this ionization process is coming from the excess Gibbs energy from the reduction process, not directly from the microwave. In previous studies, both the energy being derived from the reaction and not the microwave (only a 3 kW source) and that the plasma generated is in fact CO plasma have been confirmed. With knowledge, the plasma reaction (CO⁺+e⁻=CO and CO₂⁺+e⁻=CO₂) can be added to the ED shown in FIG. 8B. It turns out that the generated exothermic reaction (ΔG5+ΔG7) is equivalent to the endothermic energy required to ionize the plasma (ΔG6). This is a huge part of the problem as the argument can be made that this process is competitive with other processes on an MJ/ton Cu basis.

There is the additional aspect of utilizing the plasma for the processing of the e-waste, which aids in the viability of the proposed approach compared to the competing method. One additional advantage is that once the Mox is reduced, the reduced phase is quickly moved away from the other material before it can react with other oxides. As is illustrated in the ED in FIG. 8B there is a slew of other oxides that lie below copper oxide. This means copper can combine with these more stable oxides and not separate. Often this is a desired effect as more stable oxides, sometimes referred to as fluxes, will form a slag phase that can be physically removed. However, these slag phases often rely upon buoyancy forces or differences in densities to separate. This involves fully melting the material to a liquid state, and in the case of copper, this is upwards of 1600 °C, which is an energy-intensive process. This approach uses a self-limiting, local reaction, which complicates the separation process, but provides a lower energy processing cost. Fluxes can be employed to control the basicity of the reaction so it will not react with vessel walls.

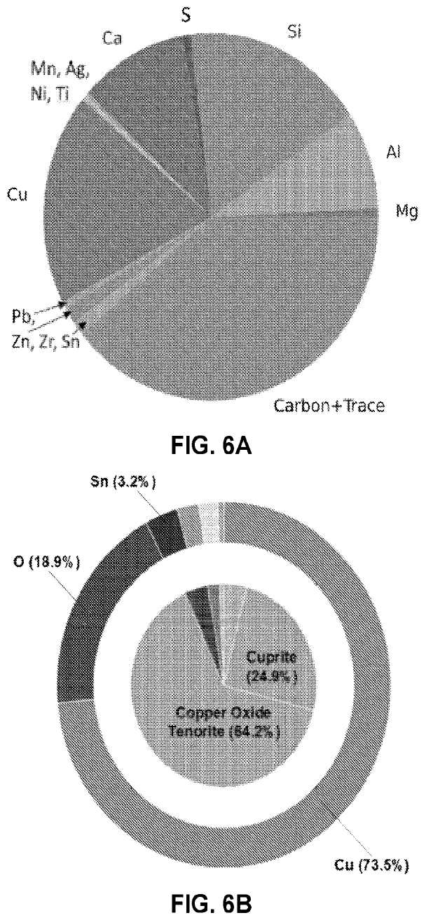

The focus of the proposed approach is to specifically separate lead from copper and also separate other materials from the e-waste stream. As discussed in FIG. 6A other materials such as tin (Sn), zinc (Zn), and calcium (Ca) are present. All of these materials are included in the ED in FIG. 8B to determine their required reaction temperatures. Focusing on lead it is important to identify how lead will present itself in the phases. It is assumed that lead will alloy with copper and form copper lead oxide. The phase diagram provided in FIG. 8A is for the Pb—Cu—O system at an elevated temperature of 1250 °C. Corresponding this temperature to the ED in FIG. 8B, it is seen at this temperature both the tenorite and cuprite oxide phases are in liquid phases. The phase diagram illustrates the solubility limit of lead in copper and copper oxide. The solubility limit in copper oxide is approximately 4.5% of Pb. Above this concentration, the Pb will phase separate. On the lower left side of the phase diagram, a copper lead alloy will form with a solubility limit of 0.5% Pb. At intermediate copper concentration between 64% and 90% Cu the liquid oxide phase will phase separate between a copper-rich phase and a copper oxide phase. In the relation to the proposed approach, there is an opportunity for the carbon and CO plasma to interact with only the L1 phase. Focusing back on the ED in FIG. 8B for the reaction 2Pb+O₂=2PbO, the oxide phase can be reduced by CO plasma at 900 °C. Moreover, the boiling point is approximately 1500 °C, where the line crosses the cuprite line. At 1500 °C lead oxide will be reduced by CO and more interestingly by copper metal. This is because cuprite (Cu₂O) is more stable at 1500 °C than lead oxide. Therefore, lead oxide will liberate its oxygen and give it to copper to form Cu₂O. At this point, it will be necessary to maintain the partial pressure (pO₂) of oxygen to avoid the formation of the oxide. Therefore, the partial pressure will be maintained at 10⁻³ atm of oxygen with a vacuum and flow of argon. Because the lead is vaporized to gas it will now leave with the plasma and condense downstream. This exact phenomenon is observed in FIG. 7B (ii) with the collection of small metallic phases on the side of the crucible, thus demonstrating phase separation.

Investigating the phase diagram in FIG. 8A it is known that 4.5% of lead can stabilize in copper oxide. Taking the ratio of lead to copper in FIG. 6A of the XRD data, it is determined to be approximately 3.4%. This provides a good indication that the majority of lead is likely alloyed with Cu. Furthermore, as seen in QPA XRD data in FIG. 8B the majority of the tin phase is cassiterite (SnO₂), which does not substitutionally alloy with lead. There is a stable phase Pb₂SnO₄, be this was not present in the XRD analysis. There is also the issue with SnPb alloy forming but this is not likely due to the evaporation of lead after reducing from copper before SnO₂ will reduce.

Other elements such as Zn and Ca can also be handled by selectively refining the mixture and following the ED provided in FIG. 8B. Zinc is a surprising component and it is believed to be coming from brass connectors, standoffs, or through-hole bushings in the PCBs. While Zn is a stable oxide but the melting point is low. The Zn metal phase was found in the XRD analysis shown in FIG. 6B, which suggests that around 900 °C, Zn metal will boil and leave the system to be condensed downstream. Calcium turns out to be one of the most stable oxides, as seen in the ED provided in FIG. 8B. Because Ca is so stable, Ca likely remains as an oxide slag phase. This knowledge can be used to protect the liner of the reaction chamber and to collect other phases, such as silicon.

The proposed methodology discussed above that involves selective refinement has been demonstrated on a material system that involves the recovery of Ta metal from capacitors. The anode material in Ta capacitors is made up of Ta metal, Ta₂O₅, Ag, and MnO₂. Using a carbothermal reduction process, the reaction temperature can be controlled to remove MnO₂ in the form of Mn₃C, which collects in the form of a condensed phase, shown in FIG. 9C. FIG. 9A is an illustration of the crucible with a multimode microwave heat to 1450 °C with a CO plasma emanating from the lid. FIG. 9B is a photo of Ta metal sponge materials that were physically separated from the crucible after the run. The Ta metal sponge material can be melted in an electron arc furnace to form ingots of Ta. The Mn₃C can be further refined to recover Mn. The energy requirement for this process is on the order of MJ/ton Ta which is required for scrap iron recycling.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

### REFERENCES

1. Krukowski, S., et al. (2006). Blue and UV semiconductor lasers. ACTA PHYSICA POLONICA SERIES B, 37(4), 1265.
2. Lamoreaux, R. H., et al. (1984). High temperature vaporization behavior of oxides. I. Alkali metal binary oxides. Journal of physical and chemical reference data, 13(1), 151-173.
3. Levêque, G., et al. (2014). Thermodynamic and kinetic study of the carbothermal reduction of SnO₂ for solar thermochemical fuel generation. Energy & fuels, 28(2), 1396-1405.
4. McCormack, S. J., et al. (2019). In-situ determination of the HfO₂—Ta₂O₅-temperature phase diagram up to 3000 C. Journal of the American Ceramic Society, 102(8), 4848-4861.
5. Sabolsky, E., et al. (2021). Methods and Compositions for Extraction of Rare Earth Elements from Coal Ash. US Patent App. Pub. No. US20210102273A1. Published Apr. 8, 2021.
6. Xue, Y. et al., A novel process to extract alumina and prepare Fe—Si alloys from coal fly ash, Fuel Processing Technology (2019). 185:151-157.
7. Zhan, L., et al. (2015). Novel recycle technology for recovering rare metals (Ga, In) from waste light-emitting diodes. Journal of Hazardous Materials, 299, 388-394.

1. A method to recover at least one metal from electronic waste, the method comprising:
(a) pyrolyzing electronic waste, wherein the electronic waste comprises the at least one metal and one or more organic components, and wherein the pyrolyzing forms a composition comprising pyrolyzed electronic waste and pyrolyzed carbon;
(b) contacting the composition with an oxidizing agent and oxidizing the composition using microwave heating to form an oxidized composition comprising at least one metal oxide containing the at least one metal and the pyrolyzed carbon; and
(c) applying microwave heating to the oxidized composition, wherein the microwave heating causes carbothermal reduction, carburization, nitridation, or a combination thereof, to form the at least one metal, at least one metal carbide, or at least one metal nitride from the at least one metal or metal oxide.

2. The method of claim 1, wherein the at least one metal, metal carbide, or metal nitride is recovered with at least 80% or greater purity.

3.-6. (canceled)

7. The method of claim 1, further comprising crushing the electronic waste to particles prior to pyrolyzing, wherein the particles have an average diameter of less than about 1 mm.

8. (canceled)

9. The method of claim 1, wherein at least a portion of the pyrolyzed carbon is produced from polymers, paints, a nonmetallic printed circuit board (PCB) component, or any combination thereof.

10. The method of claim 1, wherein the at least one metal comprises manganese or an information and communication technology (ICT) metal, wherein the ICT metal comprises indium, gallium, tantalum, copper, or any combination thereof.

11. (canceled)

12. The method of claim 10, wherein tantalum is recovered as TaC.

13. The method of claim 10, wherein nitridation is performed and wherein gallium is recovered as GaN, indium is recovered as InN, or both.

14. The method of claim 10, wherein manganese is recovered as MnO or Mn₇C₃.

15. The method of claim 10, where gallium is recovered as Ga₂O₃, indium is recovered as In₂O₃, or both, or wherein gallium and indium are recovered as Ga and In metal coatings on crucible walls.

16.-21. (canceled)

22. The method of claim 1, wherein during step (a), one or more low-melting temperature metals evaporate, and wherein the one or more low-melting temperature metals condense to a solid state after evaporation.

23.-25. (canceled)

26. The method of claim 1, wherein the oxidizing agent absorbs microwave energy, and wherein the oxidizing agent comprises magnetite, H₂O, atmospheric oxygen, or any combination thereof.

27.-29. (canceled)

30. The method of claim 1, wherein under microwave heating, the oxidizing agent is reduced to a partially reduced oxidizing agent, and wherein presence of the partially reduced oxidizing agent increases temperature and causes vaporization of the one or more metal oxides and carbon.

31. (canceled)

32. The method of claim 1, further comprising recovering iron following step (c) and oxidizing the iron with oxygen to reform the magnetite.

33. The method of claim 1, wherein, in step (c), nitridation occurs when microwave heating is conducted in a nitrogen atmosphere, and wherein nitridation results in the formation of at least one metal nitride.

34.-37. (canceled)

38. The method of claim 1, wherein during step (c), at least one high-melting temperature metal is recovered as a metal sponge material.

39. (canceled)

40. The method of claim 38, wherein a stable carbide phase of the high-melting temperature metal is formed.

41.-53. (canceled)

54. The method of claim 1, wherein step (c) comprises localized heating, a self-limiting reduction reaction, or both.

55. A system for recovering at least one metal from electronic waste, the system comprising:
(a) a microwave source that emits microwave power;
(b) an impedance matching waveguide through which the microwave power is passed;
(c) at least one reactor chamber containing a material comprising electronic waste, pyrolyzed electronic waste, oxidized composition, or any combination thereof to be processed, the at least one reactor chamber having a wall through which microwave power is passed after exiting the impedance matching waveguide; and
(d) a device for measuring system temperature.

56. The system of claim 55, wherein the system comprises a plurality of reactor chambers arranged sequentially, and wherein the system further comprises an auger for providing a continuous feed of the material to the plurality of reactor chambers.

57. The system of claim 55, wherein the system further comprises a vacuum apparatus for applying a vacuum to the at least one reactor chamber.

58. The method of claim 1, wherein in step (c), the microwave heating oxidizes the pyrolyzed carbon to carbon monoxide, wherein the carbon monoxide reduces the at least one metal or metal oxide
